(19) United States
(12) Patent Application Publication
(10) Pub. No.: US 2015/0221162 A1
(43) Pub. Date: Aug. 6, 2015

(54) Systems and methods for networked bingo

(71) Applicant: Pridefield Limited, Douglas (IM)

(72) Inventors: Leslie Craig Peters, Pinetown (ZA); David Michael Reynolds, Douglas (IM); Edward Alan Meek, Durban North (ZA)

(21) Appl. No.: 14/606,122

(22) Filed: Jan. 27, 2015

(30) Foreign Application Priority Data
Jan. 31, 2014 (GB) 1401686.9

(51) Int. Cl. G07F 17/32

(52) U.S. Cl. CPC G07F 17/329; G07F 17/3211

(57) ABSTRACT

Systems and methods for networked bingo are described. A machine can generate enhanced bingo tickets including symbols that can be called for a networked bingo match and extra symbols, such as a globally-designated scatter symbol that is applicable to all bingo tickets competing in the bingo match. The extra symbols can also include locally-designated extra symbols, such as a bonus trigger symbol, a bonus-counter symbol, and a multiplier symbol, that are applicable to individual bingo tickets. A first machine can provide a second machine with one or more enhanced bingo tickets over a communication network. The first and second machines can store the bingo ticket(s) as a data structure in memory. The first machine can send a symbol sequence indicating the symbols called for the bingo match. The symbol sequence can include indicators of the extra symbols being called or symbols associated with the extra symbols being called.

### PRIORITY

This application claims priority under 35 U.S.C. §119 to United Kingdom Patent Application No. 1401686.9 filed Jan. 31, 2014. United Kingdom Patent Application No. 1401686.9 is hereby incorporated by reference in its entirety.

### BACKGROUND

This disclosure relates to a system for playing a bingo-type game.

The Internet and other data networks have facilitated the growth of real-time or near-real-time networked gaming. Players from around the world can log on to a gaming server and enjoy competing against one another in a computer-mediated contest over a computer network, such as the Internet. These matches can be played for fun, entertainment, or for gain.

Bingo is a well-known game of chance involving two or more players. Traditional bingo is played on predetermined “tickets” in the form of paper cards that include a number of symbols selected from a global symbol set and arranged in a row-and-column grid, each grid position containing a symbol. Each ticket generally includes a subset of symbols in the global symbol set. A symbol is typically a number selected randomly and without replacement from a number range, for example the numbers 1 through 90. Each bingo ticket contains a different combination and arrangement of symbols. Each bingo ticket may also contain one or more “free” spaces that are not associated with a symbol.

During play of a bingo match, symbols are selected randomly, generally without replacement, from the global symbol set and matched to the symbols on each ticket. A ticket having matching symbols arranged in a pre-defined pattern is a winning ticket and qualifies for the award of a prize. The match ends when one of the players' tickets is the first to exhibit a pre-defined pattern of grid markings. A common match-ending pattern is for all of the grid positions on a ticket to be marked. However other match-ending patterns may be defined. The winner of the match is usually the first player to achieve the match-ending pattern.

A disadvantage of bingo games is that the probability of winning a prize, or losing the cost of purchasing a ticket is always determined by a fixed set of constraints, which include the number of symbols in the global symbol set, the pre-defined pattern of symbols to be matched on a ticket, and the number of grid positions on the ticket.

Like many games of chance, bingo has been implemented and deployed so that it can be played over computer networks. Networked bingo has the advantage of reaching a market segment of players who would prefer to play bingo from the comfort of their own homes. Operators of networked bingo matches compete with one another for players. The more players that play with a given operator, the more revenue that operator is able to generate. Therefore, operators of networked bingo matches seek to differentiate their services by offering new and unique variations of bingo that may attract more players. It is desirable to enhance bingo-type games with additional features that provide bingo players with additional winning opportunities, thereby increasing players' interest, anticipation and excitement in connection with the game. It is desirable to provide methods and machines to generate or provide enhanced bingo tickets and methods and machines to carry out bingo matches using enhanced bingo tickets.

### OVERVIEW

To this end, the operation of new types of bingo matches between players over a network such as the Internet can more easily facilitate the development and market testing of these matches, due to the ability of the networks to rapidly reach a large and targeted market of players. Disclosed herein are systems and methods that relate to supplementary win features in a bingo-style game using enhanced bingo tickets including one or more bingo strips.

In the example embodiments of the disclosure in which a computer software product is used, the product may be non-transitory and store instructions on physical media such as a DVD, or a solid state drive, or a hard drive. Alternatively, the product may be transitory and in the form of instructions provided over a connection such as a network connection which is linked to a network such as the internet.

An example embodiment of such a networked bingo game includes a server device, a database, a number of web portals, and a number of client devices coupled to the server device via a communication network, and the database storing profiles associated with each player. Players, operating the client devices, request to join a networked bingo match. Each iteration of the match involves the server device randomly selecting a symbol from the set of symbols and then checking each bingo ticket of each player to determine if the symbol appears on the ticket. If the symbol appears on the ticket, the grid position on the ticket containing the symbol is marked. Furthermore, the server device checks if the selected symbol is associated with a special or extra symbol on the bingo ticket. If it is, a corresponding game feature can be activated for that ticket that may improve a player's chances of being awarded a prize. The prize may be progressive in nature; thus, the prize may grow in value until won.

In a first respect, an example embodiment takes the form of a method comprising: (i) generating, by a computer-readable processor, computer-readable bingo tickets, (ii) providing, over a communication network, multiple generated bingo tickets for use in a networked bingo match, wherein the multiple generated bingo tickets include a first bingo ticket, (iii) selecting, by the processor, the first bingo ticket to include a bonus-counter symbol, (iv) selecting, by the processor, a first symbol on the first bingo ticket within a first grid position for including the bonus-counter symbol on the first bingo ticket, (v) selecting, by the processor and from among a set of selectable symbols, a set of symbols for the networked bingo match, and (vi) determining, by the processor from among the multiple bingo tickets provided for use in the networked bingo match and based on the selected set of symbols, a winning bingo ticket that wins the networked bingo match.

In a second respect, an example embodiment can take the form of a machine comprising: a computer-readable processor, and a computer-readable data storage medium storing computer-readable program instructions, that when executed by the processor, cause a set of functions to be performed, the set of functions comprising: (i) generating, by a computer-readable processor, computer-readable bingo tickets, (ii) providing, over a communication network, multiple generated bingo tickets for use in a networked bingo match, wherein the multiple generated bingo tickets include a first bingo ticket, (iii) selecting, by the processor, the first bingo ticket to include a bonus-counter symbol, (iv) selecting, by the processor, a first symbol on the first bingo ticket within a first grid position for including the bonus-counter symbol on the first bingo ticket, (v) selecting, by the processor and from among a set of selectable symbols, a set of symbols for the networked bingo match, and (vi) determining, by the processor from among the multiple bingo tickets provided for use in the networked bingo match and based on the selected set of symbols, a winning bingo ticket that wins the networked bingo match.

In a third respect, an example embodiment takes the form of a method comprising: (i) receiving, by a communication interface from a communication network, a first bingo ticket generated for use in a networked bingo match, wherein the first bingo ticket includes multiple symbols, including a first symbol, from a set of symbols defined for generating bingo tickets, and wherein the first bingo ticket includes a bonus-counter symbol, (ii) receiving, by the communication interface from the communication network, a set of symbols selected for multiple bingo tickets competing in the networked bingo match from among a set of symbols selectable for the networked bingo match, (iii) displaying, by a display, the received first bingo ticket, wherein displaying the first bingo ticket includes displaying the first symbol and the bonus-counter symbol within a first grid position selected for including the first symbol and the bonus-counter symbol on the first bingo ticket, and (iv) displaying, by the display, the received set of selected symbols being marked on the displayed first bingo ticket to display an outcome of the networked bingo match.

In a fourth respect, an example embodiment takes the form of a machine comprising: a computer-readable processor, a display, a communication interface, and a computer-readable data storage medium storing computer-readable program instructions, that when executed by the processor, cause a set of functions to be performed, the set of functions comprising: (i) receiving, by the communication interface from a communication network, a first bingo ticket generated for use in a networked bingo match, wherein the first bingo ticket includes multiple symbols, including a first symbol, from a set of symbols defined for generating bingo tickets, and wherein the first bingo ticket includes a bonus-counter symbol, (ii) receiving, by the communication interface from the communication network, a set of symbols selected for multiple bingo tickets competing in the networked bingo match from among a set of symbols selectable for the networked bingo match, (iii) displaying, by the display, the received first bingo ticket, wherein displaying the first bingo ticket includes displaying the first symbol and the bonus-counter symbol within a first grid position selected for including the first symbol and the bonus-counter symbol on the first bingo ticket, and (iv) displaying, by the display, the received set of selected symbols being marked on the displayed first bingo ticket to display an outcome of the networked bingo match.

In a fifth respect, an example embodiment takes the form of a method comprising: (i) generating, by a computer-readable processor, computer-readable bingo tickets, (ii) providing, over a communication network, multiple generated bingo tickets for use in a networked bingo match, wherein the multiple generated bingo tickets include a first bingo ticket, (iii) selecting, by the processor, the first bingo ticket to include a bonus trigger symbol, (iv) selecting, by the processor, a first symbol on the first bingo ticket within a first grid position for including the bonus trigger symbol, (v) selecting, by the processor and from among a set of selectable symbols, a set of symbols for the networked bingo match, and (vi) determining, by the processor from among the multiple bingo tickets provided for use in the networked bingo match and based on the selected set of symbols, a winning bingo ticket that wins the networked bingo match.

In a sixth respect, an example embodiment takes the form of a machine comprising: a computer-readable processor, a computer-readable data storage medium storing computer-readable program instructions, that when executed by the processor, cause a set of functions to be performed, the set of functions comprising: (i) generating, by a computer-readable processor, computer-readable bingo tickets, (ii) providing, over a communication network, multiple generated bingo tickets for use in a networked bingo match, wherein the multiple generated bingo tickets include a first bingo ticket, (iii) selecting, by the processor, the first bingo ticket to include a bonus trigger symbol, (iv) selecting, by the processor, a first symbol on the first bingo ticket within a first grid position for including the bonus trigger symbol, (v) selecting, by the processor and from among a set of selectable symbols, a set of symbols for the networked bingo match, and (vi) determining, by the processor from among the multiple bingo tickets provided for use in the networked bingo match and based on the selected set of symbols, a winning bingo ticket that wins the networked bingo match.

In a seventh respect, an example embodiment takes the form of a method comprising: (i) receiving, by a communication interface from a communication network, a first bingo ticket generated for use in a networked bingo match, wherein the first bingo ticket includes a bonus trigger symbol and a first symbol, and wherein the bonus trigger symbol and the first symbol are positioned within a first grid position on the first bingo ticket, (ii) displaying, by a display, the received first bingo ticket, wherein displaying the first bingo ticket includes displaying the first bingo ticket including the first symbol and the bonus trigger symbol within the first grid position, (iii) receiving, by the communication interface from the communication network, a set of symbols selected for multiple bingo tickets competing in the networked bingo match from among a set of symbols selectable for the networked bingo match, and (iv) displaying, by the display, the received set of selected symbols being marked on the displayed first bingo ticket to display an outcome of the networked bingo match.

In an eighth respect, an example embodiment takes the form of a machine comprising: a computer-readable processor, a display, a communication interface, and a computer-readable data storage medium storing computer-readable program instructions, that when executed by the processor, cause a set of functions to be performed, the set of functions comprising: (i) receiving, by the communication interface from a communication network, a first bingo ticket generated for use in a networked bingo match, wherein the first bingo ticket includes a bonus trigger symbol and a first symbol, and wherein the bonus trigger symbol and the first symbol are positioned within a first grid position on the first bingo ticket, (ii) displaying, by the display, the received first bingo ticket, wherein displaying the first bingo ticket includes displaying the first bingo ticket including the first symbol and the bonus trigger symbol within the first grid position, (iii) receiving, by the communication interface from the communication network, a set of symbols selected for multiple bingo tickets competing in the networked bingo match from among a set of symbols selectable for the networked bingo match, and (iv) displaying, by the display, the received set of selected symbols being marked on the displayed first bingo ticket to display an outcome of the networked bingo match.

In a ninth respect, an example embodiment takes the form of a method comprising: (i) generating, by a computer-readable processor, computer-readable bingo tickets, (ii) providing, over a communication network, multiple generated bingo tickets for use in a networked bingo match, wherein the multiple generated bingo tickets include a first bingo ticket, (iii) selecting, by the processor and from among a set of selectable symbols, a set of symbols for the networked bingo match, wherein selecting the set of symbols includes selecting multiple distinct symbols, and wherein the set of selectable symbols includes a scatter symbol, (iv) determining, by the processor, a selected symbol of the set of symbols for the networked bingo match is the scatter symbol, (v) determining, by the processor for each bingo ticket provided for the networked bingo match, a respective quantity of symbols to be marked on each bingo ticket provided for the networked bingo match in response to the scatter symbol being selected, (vi) selecting, by the processor for each bingo ticket provided for the networked bingo match, a quantity of unmarked symbols on the bingo ticket that equals the respective quantity of symbols selected for the bingo ticket, (vii) marking, by the processor for each bingo ticket provided for the networked bingo match, each grid position on the bingo ticket that includes an unmarked symbol of the quantity of unmarked symbols selected for the bingo ticket, and (viii) determining, by the processor from among the multiple bingo tickets provided for use in the networked bingo match and based on the selected set of symbols, a winning bingo ticket that wins the networked bingo match.

In a tenth respect, an example embodiment takes the form of a machine comprising: a computer-readable processor, a computer-readable data storage medium storing computer-readable program instructions, that when executed by the processor, cause a set of functions to be performed, the set of functions comprising: (i) generating, by a computer-readable processor, computer-readable bingo tickets, (ii) providing, over a communication network, multiple generated bingo tickets for use in a networked bingo match, wherein the multiple generated bingo tickets include a first bingo ticket, (iii) selecting, by the processor and from among a set of selectable symbols, a set of symbols for the networked bingo match, wherein selecting the set of symbols includes selecting multiple distinct symbols, and wherein the set of selectable symbols includes a scatter symbol, (iv) determining, by the processor, a selected symbol of the set of symbols for the networked bingo match is the scatter symbol; (v) determining, by the processor for each bingo ticket provided for the networked bingo match, a respective quantity of symbols to be marked on each bingo ticket provided for the networked bingo match in response to the scatter symbol being selected, (vi) selecting, by the processor for each bingo ticket provided for the networked bingo match, a quantity of unmarked symbols on the bingo ticket that equals the respective quantity of symbols selected for the bingo ticket, (vii) marking, by the processor for each bingo ticket provided for the networked bingo match, each grid position on the bingo ticket that includes an unmarked symbol of the quantity of unmarked symbols selected for the bingo ticket, and (viii) determining, by the processor from among the multiple bingo tickets provided for use in the networked bingo match and based on the selected set of symbols, a winning bingo ticket that wins the networked bingo match.

In an eleventh respect, an example embodiment takes the form of a method comprising: (i) receiving, by a communication interface from a communication network, a first bingo ticket generated for use in a networked bingo match, (ii) receiving, by the communication interface from the communication network, a set of symbols selected for multiple bingo tickets competing in the networked bingo match from among a set of symbols selectable for the networked bingo match, wherein the set of selected symbols includes a scatter symbol that applies to the multiple bingo tickets generated for use in the networked bingo match, and wherein the scatter symbol is not selectable for generating the multiple bingo tickets competing in the networked bingo match, (iii) displaying, by a display, the received first bingo ticket, (iv) displaying, by the display, an indication the scatter symbol was selected for the networked bingo game, and (v) displaying, by the display, the received set of selected symbols being marked on the displayed first bingo ticket to display an outcome of the networked bingo match.

In a twelfth respect, an example embodiment takes the form of a machine comprising: a computer-readable processor, a display, a communication interface, and a computer-readable data storage medium storing computer-readable program instructions, that when executed by the processor, cause a set of functions to be performed, the set of functions comprising: (i) receiving, by the communication interface from a communication network, a first bingo ticket generated for use in a networked bingo match, (ii) receiving, by the communication interface from the communication network, a set of symbols selected for multiple bingo tickets competing in the networked bingo match from among a set of symbols selectable for the networked bingo match, wherein the set of selected symbols includes a scatter symbol that applies to the multiple bingo tickets generated for use in the networked bingo match, and wherein the scatter symbol is not selectable for generating the multiple bingo tickets competing in the networked bingo match, (iii) displaying, by the display, the received first bingo ticket, (iv) displaying, by the display, an indication the scatter symbol was selected for the networked bingo game, and (v) displaying, by the display, the received set of selected symbols being marked on the displayed first bingo ticket to display an outcome of the networked bingo match.

These and other aspects and advantages will become apparent to those of ordinary skill in the art by reading the following detailed description, with reference where appropriate to the accompanying drawings. Further, it should be understood that the foregoing overview is merely for purposes of illustration and is not intended to limit the scope of the invention as claimed.

### DESCRIPTION OF THE FIGURES

FIG. 1 is a simple block diagram of a networked bingo client/server architecture in accordance with the example embodiments.

FIG. 2 is a flow chart depicting a set of functions pertaining to processing registrations and payments for networked bingo in accordance with the example embodiments.

FIG. 3 depicts an example bingo strip and data structure storing grid position identifiers in accordance with the example embodiments.

FIG. 4 is a pictorial representation of symbol sets for a networked bingo match.

FIG. 5 is a flow chart depicting a set of functions pertaining to generating bingo strips and associating extra symbol(s) with a bingo strip in accordance with the example embodiments.

FIG. 6A is a flow chart depicting a set of functions pertaining to performing an iteration of networked bingo in accordance with the example embodiments.

FIG. 6B is a flow chart depicting a set of functions pertaining to performing an iteration of networked bingo in accordance with the example embodiments

FIG. 6C is a flow chart depicting a set of functions pertaining to performing an iteration of networked bingo in accordance with the example embodiments

FIG. 7 is a flow chart depicting a set of functions pertaining to a jackpot game in accordance with the example embodiments.

FIG. 8 is a flow chart depicting a set of functions pertaining to a progressive prize in a networked bingo match in accordance with the example embodiments.

FIG. 9 is a flow chart depicting a set of functions pertaining to use of a bonus trigger symbol in a networked bingo match in accordance with the example embodiments.

FIG. 10 is a flow chart depicting a set of functions pertaining to use of a bonus trigger symbol in a networked bingo match in accordance with the example embodiments.

FIG. 11 illustrates an example bingo match sequence.

### DETAILED DESCRIPTION

### I. Introduction

This description describes several example embodiments pertaining to networked bingo games. The implementation of the described networked bingo games affords operators of these games options and variations that may not be possible or practical in traditional bingo play. In order to support these options and variations, networked bingo can be formally described in more general terms than those used in traditional bingo. Accordingly, networked bingo may use multiple sets of symbols, a set of enhanced bingo tickets (or more simply “bingo tickets’), an enhanced bingo strip (or more simply, a “bingo strip”), one or more variations of match play, and a prize or prizes (i.e., award(s)). Each of these elements is described in more detail below, and may be combined in various ways to define new methods, devices, and systems for networked bingo.

In this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using those articles is that there is one or more of the elements. The intent of using the conjunction “or” within a described list of at least two terms is to indicate any of the listed terms or any combination of the listed terms. The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

The block diagram(s) and flow chart(s) shown in the figures are provided merely as examples and are not intended to be limiting. Many of the elements illustrated in the figures or described herein are functional elements that can be implemented as discrete or distributed elements or in conjunction with other elements, and in any suitable combination and location. Those skilled in the art will appreciate that other arrangements and elements (e.g., machines, interfaces, functions, orders, or groupings of functions) can be used instead. Furthermore, various functions described as being performed by one or more elements can be carried out by a processor executing computer-readable program instructions or by any combination of hardware, firmware, or software.

### II. Symbol Sets for Networked Bingo

Multiple sets of symbols can be defined for networked bingo using bingo strips or bingo tickets. FIG. 4 shows a pictorial representation of sets of symbols (or more simply, “symbol sets”) 400, 402, and 404. Symbol sets 400, 402, and 404 can include computer-readable symbols stored in a computer-readable data storage device. Symbol set 400 is a set of symbols from which symbols for a networked bingo match can be selected by a processor. As shown in FIG. 4, symbol set 400 includes a scatter symbol 406 and symbol set 402. Use of scatter symbol 406 is described elsewhere herein.

Symbol set 402 can be a proper subset of symbol set 400. Symbol set 402 can include symbols representing whole numbers 1 to N. As an example, to be similar to a first traditional version of bingo, N can be 75 so that symbol set 402 includes symbols representing the numbers 1 through 75, inclusive. As another example, to be similar to a second traditional version of bingo, N can be 90 so that symbol set 402 includes symbols representing the numbers 1 through 90, inclusive. Symbol set 402 can include symbols selectable for generating a bingo ticket. A symbol that is within symbol set 400 but that is not within symbol set 402 (e.g., scatter symbol 406) can be a symbol that is not selectable for generating a bingo ticket.

The example embodiments of networked bingo described herein are configurable such that the value of N is 75, 90, or some other number. Moreover, in example embodiments of networked bingo described herein, the symbols are not restricted to being numbers or numerical values, but may include letters, punctuation marks, symbols from phonemic, syllabic, or logographic alphabets or writing systems, pictures, or any other representation of information.

Symbol set 404 can include a symbol set 416 that matches symbol set 402, and one or more other symbols that are selectable for generating a bingo ticket or ticket. Symbol set 416 can be a proper subset of symbol set 404. As an example, the one or more other symbols can include a bonus-counter symbol 408, a multiplier symbol 410, a bonus trigger symbol 412, or a free space symbol 414. Uses of bonus-counter symbol 408, multiplier symbol 410, and bonus trigger symbol 412 are described elsewhere herein.

One or more of symbol sets used in the example networked bingo games may be non-repeating or repeating. For non-repeating sets of symbols, each symbol appears exactly once in the set, while in repeating sets of symbols, each symbol may appear in the set more than once.

While in traditional bingo, the symbols are usually represented on physical balls, in a computerised networked bingo match, there is no need for physical balls and instead the symbols may be represented though various means in computer memory and displayed on a computer screen or some other medium.

### III. Bingo Tickets and Bingo Strips

Each player of a networked bingo match is provided one or more bingo tickets to be used in a networked bingo match. Each player may choose, purchase, or be given the bingo ticket(s) provided to the player. Each bingo ticket includes a grid with multiple grid positions. Each grid position on or within the grid includes one or more symbols chosen from a set of symbols defined for generating a bingo ticket (e.g., the symbol set 404).

Providing a bingo ticket to a player can include providing the bingo ticket to a machine for the player (or more simply, the “player's machine”). A server machine that generates a bingo ticket can transmit the bingo ticket to a communication network for transmission, in turn, to the machine for the player. The bingo ticket is a computer-readable bingo ticket. The player's machine can be configured to display the bingo ticket provided thereto. The player's machine can include or be coupled to a printing device to provide a printed copy of a bingo ticket provided to the player's machine.

A bingo ticket can include one or more grids. Each grid is displayable as having a grid shape, such as, but not limited to, a square, a rectangle, a diamond, or an irregular shape. Each grid can be configured as or include a grid matrix (or more simply, a “matrix”) having X rows, Y columns, and X times Y grid positions. As an example, X and Y each equal 5 such that the grid includes a 5-by-5 matrix with 5 rows, 5 columns, and 25 grid positions. As another example, X equals 3 and Y equals 9 such that the grid includes a 3-by-9 matrix with 3 rows, 9 columns, and 27 grid positions.

Each grid position can be selected to include a symbol from the symbol set 404. The symbols in the grid positions may be chosen from symbol set 416 either with or without replacement. If the symbols are chosen with replacement, each symbol may appear more than one time on a bingo ticket. If the symbols are chosen without replacement, each symbol may appear no more than once on each bingo ticket. Additional symbols of symbol set 404, such as symbols indicating a “free space”, may appear in any position on a bingo ticket. The distribution of symbols to bingo ticket grid positions may be pre-chosen or dynamically chosen, preferably randomly or pseudo-randomly chosen. Thus, bingo tickets may be generated and stored for later use, or may be generated in real time, as needed.

It can be appreciated that a wide variety of types of bingo tickets can be created in accordance with this definition. For a particular embodiment of bingo, symbol set 416 can include 90 symbols representing the numbers 1 through 90. Each row of a bingo ticket including the 3-by-9 matrix described above can include 5 grid positions including symbols from symbol set 416 and 4 grid positions including “free space” symbols. Each of those bingo tickets includes 15 symbols from symbol set 416. Each of the 15 symbols being randomly associated with one of the 27 grid positions on the bingo ticket.

A number of bingo tickets, for example 6 bingo tickets, may be grouped together. Such a grouping is called a bingo “strip”. In the example embodiment in which symbol set 402 includes 1 to N symbols and N equals 90, a bingo strip can include each distinct symbol from 1 to 90 in a respective grid position on the bingo strip only once. In accordance with at least some of the example embodiments, for every symbol “called” in the bingo match, at least one grid position will be marked across the 6 bingo tickets in the strip. Of course, many other variations of networked bingo, either including tickets or not including tickets, may be defined.

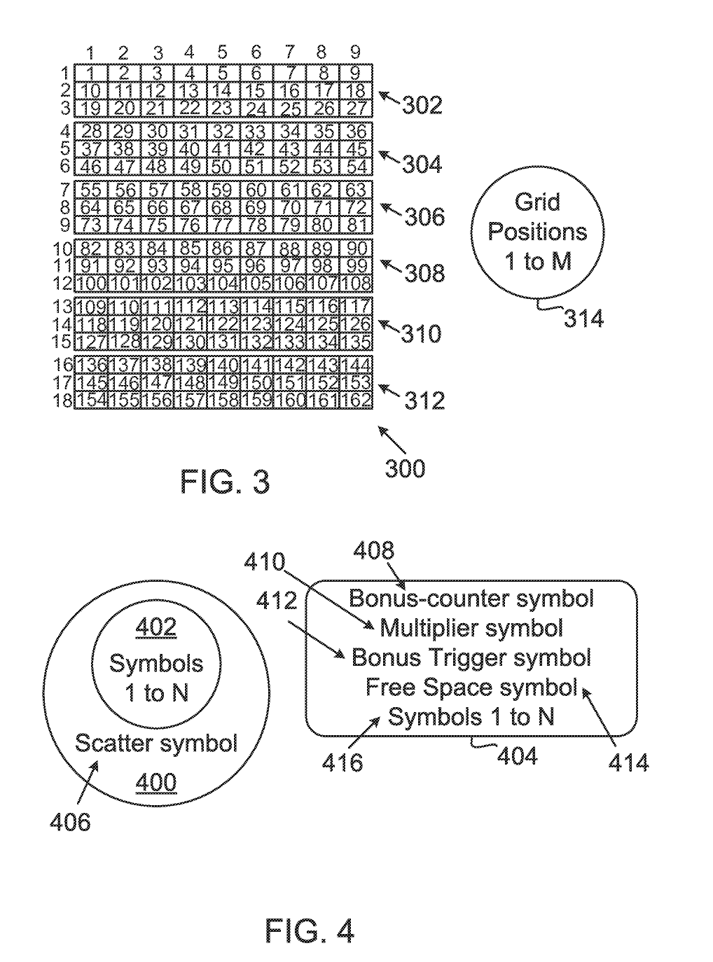

FIG. 3 depicts an example bingo strip 300 including bingo tickets 302, 304, 306, 308, 310, and 312 (or more simply, “bingo tickets 302 to 312”). Each of the bingo tickets 302 to 312 includes a 3-by-9 matrix and 27 grid positions. The row numbers for bingo tickets 302 to 312 are numbered 1 to 18, inclusive, and the column numbers for bingo tickets 302 to 312 are numbered 1 to 9, inclusive.

A bingo strip includes M grid positions. For bingo strip 300, M equals 162. Each grid position can be identified using any of a variety of grid identifiers. As an example, M grid positions of bingo strip 300 can be numbered 1 to 162, inclusive. A different grid position identification scheme can be used. For instance, the grid positions can be identified by a row identifier and a column identifier. For example, grid position 111 could be identified as grid position (13, 3) where the row is listed before the column, or grid position (3, 13) where the column is listed before the row. The grid identifiers for grid positions 1 to M can be stored in a data storage device as grid positions 314.

For a bingo match in which a symbol from symbol set 400 is selected with replacement, a bingo ticket can be generated to have multiple instances of a single symbol from the symbol set 416. Each time the single symbol is selected for the bingo match, a single grid position including the single symbol can be marked.

### IV. Networked Bingo Matches

Networked bingo can be played in various ways. An example method of match play is for each player to use one or more bingo tickets in a match. Each bingo ticket begins unmarked, except for “free” spaces that are either pre-marked by default or otherwise considered to be marked for purposes of scoring. Players may be required to purchase the one or more bingo tickets as a fee for entry into a game. From these fees, the networked bingo operator may collect a percentage, or “rake,” which contributes to the operator's revenue.

Each iteration, or turn, of a match consists of a new or next symbol being chosen from symbol set 400. The symbols may be chosen either with or without replacement. If the symbols are chosen with replacement, each symbol may be chosen more than once per match. If the symbols are chosen without replacement, each symbol may be chosen no more than once per match. Once a symbol is chosen, it may be “called” or otherwise indicated to the players, preferably over a communication network. Additionally, each bingo ticket of each player in the match may be checked to determine if the bingo ticket contains the called symbol in a grid position. If the bingo ticket includes the called symbol, the symbol is preferably marked on the ticket. This marking may take the form of highlighting the symbol in some fashion, such as changing its color, graying it out, circling it, or otherwise indicating that the symbol has been chosen from the set of symbols. A sequence of chosen symbols may be pre-chosen or dynamically chosen, preferably randomly or pseudo-randomly chosen. These iterations of “calling” and marking continue until the bingo match concludes.

The act of marking a bingo ticket may be referred to as “daubing.” In traditional bingo a player must “daub” the appropriate positions on his or her bingo tickets as each symbol is “called.” However, in networked bingo, a player may be required to “daub,” or the networked bingo game may automatically “daub” (i.e., mark) the appropriate positions on each player's bingo tickets.

Networked bingo match play can further include one or more match-ending patterns as well as one or more optional intermediate patterns. A match-ending pattern is preferably a pattern of markings on a bingo ticket that, when achieved on a bingo ticket, causes the bingo match to end. A typical match-ending pattern is a pattern on a bingo ticket having all grid positions, including both grid positions with symbols from the set of symbols as well as any “free space” grid positions, having been marked. Other match-ending patterns may be defined, however.

Preferably, a player using a machine displaying a bingo ticket that first achieves a match-ending pattern wins the bingo match. It is possible for more than one player to achieve the match-ending pattern on the same iteration of the bingo match. In this case, all of the players achieving the match-ending pattern may be considered to have won the match.

An intermediate pattern is preferably a pattern of markings on a bingo ticket that confers a particular status or benefit upon a player who achieves it on a bingo ticket provided for that player. For example, an intermediate pattern may be defined to be all of the symbols in one or more rows, columns, or diagonals on a bingo ticket being marked. More complex intermediate patterns may be defined, however, such as all of the grid positions in a square, rectangle, or diamond shape being marked. Intermediate patterns may be arbitrarily defined based on the grid configuration on one or more tickets, or based on some other means. Like match-ending patterns, grid positions indicated as “free” may be considered to be marked for purposes of determining when an intermediate pattern is achieved.

Preferably, the first player to achieve an intermediate pattern is awarded the status or benefit associated with the intermediate pattern. It is possible for more than one player to achieve the intermediate pattern on the same iteration of the bingo match. In this case, all of the players achieving the intermediate pattern may be awarded or may share the status or benefit. Furthermore, the intermediate pattern may be associated with different statuses or benefits for each player than achieves the intermediate pattern. For example, the first player to achieve an intermediate pattern may be awarded one status or benefit, while players to achieve the intermediate pattern on subsequent iterations of the networked bingo match may be awarded different statuses or benefits.

For variations of networked bingo that use a strip of tickets, match-ending patterns and intermediate patterns may need only appear on one or more of the strips, rather than across the entire ticket. For example, a match-ending pattern may be defined to be particular pattern that appears on any strip, and the first player to exhibit that pattern on at least one of his or her strips is determined to be the winner of the match.

### V. Prizes

Match-ending patterns, intermediate patterns, or other events in a networked bingo game may be associated with prizes. The prizes may be monetary or may have some other value. Examples of non-monetary prizes include goods or services, options to buy goods or services, chances in a raffle, an opportunity to meet a celebrity or particular person or persons, or any other valuable good, commodity, service, or benefit.

Prizes may also be progressive in nature. A progressive prize is typically a prize that is not necessarily awarded in each bingo match, but increases in value for each bingo match played. For example, a progressive prize of monetary value may begin at a certain minimum level, say 100 dollars. For each bingo match played for which the progressive prize is not awarded, the progressive prize may increase in value by a fixed amount, by a percentage of the cost of entry to the match paid by each player, or according to some other formula. Thus, the more bingo matches played, the larger the progressive prize, the more attractive the game is to players, and the higher the potential revenue for the networked bingo match operator.

### VI. Variations

It will be appreciated that the means for playing networked bingo described above include virtually limitless variations of bingo matches and game play. Thus, virtually unlimited example embodiments of bingo can be defined. In one example embodiment described herein, each player wishing to participate in the bingo match may be required to purchase at least one bingo ticket including one bingo strip. A player may, of course, purchase multiple bingo tickets for the bingo match.

Each bingo strip that is in play (e.g., competing) in the bingo match may be randomly designated as having an associated “bonus-counter” symbol. The bonus-counter symbol can take the form of a medal or medallion, or some other form. One of the symbols or grid positions on each bingo strip that has been designated as having the bonus-counter symbol is randomly assigned to be or include the bonus-counter symbol on that bingo strip. If the bonus-counter symbol or a symbol associated with the bonus-counter symbol on a player's bingo strip is called, a bonus-counter symbol counter associated with the player is adjusted by a count of 1. Adjusting a bonus-counter symbol counter can include incrementing or decrementing the counter.

Each bingo strip that has been designated as having the bonus-counter symbol may be randomly associated with a multiplier symbol, such as a “2×” multiplier symbol. One of the symbols, other than the bonus-counter symbol, on each bingo strip that is designated as having the 2× multiplier symbol is randomly assigned to be the 2× multiplier symbol on that strip. If the 2× multiplier symbol or the symbol associated with the 2× multiplier symbol on a player's strip is called and the bonus-counter symbol on the player's strip is subsequently called within the next 5 symbols in the calling sequence, the bonus-counter symbol counter associated with the player is incremented by a count of 1 times the value on the multiplier symbol (e.g., 1 times 2 for the 2× multiplier symbol). In one or more of the example embodiment, a number of symbols other than 5 may be used in place of the “next 5 symbols.”

Once a player's bonus-counter symbol counter has reached a predetermined threshold, the player may become eligible to participate in a jackpot game. The jackpot game may have multiple different prizes, of which the player must win one. The prizes may be monetary prizes of different fixed amounts, or of different progressive jackpot amounts. In one particular embodiment, one of the prizes may be a predetermined number of free plays of a non-bingo game, for example a video slot game.

In one particular embodiment the jackpot game may be represented by a multi-segment wheel, each segment of the wheel being associated with a respective one of the multiple different prizes. The player may initiate the jackpot game by causing the multi-segment wheel to spin and to eventually come to rest. The player may then win the jackpot prize associated with the wheel segment that comes to rest adjacent a fixed pointer.

After the player has participated in the jackpot game, the player's bonus-counter symbol counter may be reset to an initial value, such as 0, 10, 20, or some other value. For initial values of the bonus-counter symbol counter greater than 0, an end value of the bonus-counter symbol counter may be 0, and adjusting the bonus-counter symbol counter includes decrementing the counter. For an initial value of the bonus-counter symbol counter equal to 0 and an end value of the bonus-counter symbol counter greater than 0, adjusting the bonus-counter symbol counter includes incrementing the counter.

As described herein, symbol set 400 includes a scatter symbol. The scatter symbol is not associated with a grid position on a bingo strip. The scatter symbol may be called, randomly, at any stage during the calling sequence of chosen symbols in the bingo match. In an example embodiment, the scatter symbol may not be called at all during a bingo match.

When the scatter symbol is called, at least one undaubed (i.e., unmarked) symbol is daubed (i.e., marked) on each bingo strip that is in play in the bingo match. On each bingo strip in play, the at least one symbol to be daubed pursuant to calling of the scatter symbol may be chosen randomly. Thus, each player will obtain at least one “free” daub on each strip that the player has purchased. The scatter symbol is a globally-designated symbol that applies to all bingo tickets competing in a networked bingo match.

In an example embodiment, when the scatter symbol or a symbol associated with the scatter symbol is called as described herein, each player may randomly obtain either one or, alternatively, two such “free” daubs on each strip that the player has purchased.

In one example embodiment described herein, one of the symbols on each strip in play in the bingo match may be associated with or designated as a bonus trigger symbol. The symbol on the bingo strip to be associated with or designated as the bonus trigger symbol may be selected randomly. When the bonus trigger symbol or a symbol associated with the bonus trigger symbol of a bingo strip is called during the calling sequence of chosen symbols in the bingo match, a bonus feature of the bingo match may be triggered for that particular bingo strip.

In one example embodiment, the bonus feature may involve daubing 1, 2 or 3 additional undaubed (i.e., unmarked) symbols on the bingo strip. The choice of the quantity of additional undaubed symbols to be daubed (i.e. whether 1, 2 or 3 undaubed symbols) may be randomly determined, and the specific additional undaubed symbols to daub may also be chosen randomly.

In another example embodiment, the bonus feature may involve daubing 1, 2, 3 or 4 additional undaubed symbols on the bingo strip. The choice of the quantity of additional undaubed symbols to be daubed (i.e. whether 1, 2, 3 or 4 undaubed symbols) may be randomly determined, and the particular additional undaubed symbols to daub may also be chosen randomly.

In yet another example embodiment, the bonus feature may involve temporarily daubing all of the symbols in a column of the bingo strip in which the bonus trigger symbol occurs or is positioned. For example, in the 90-ball embodiment of the bingo game in which a bingo strip includes 6 tickets, each having 3 rows and 9 columns, the column in which the bonus trigger symbol occurs (the “trigger column”) will consist of up to 18 grid positions on the strip that may be daubed temporarily. The temporary daubing of the symbols in the trigger column may persist while the next 5 symbols in the calling sequence are called, and afterwards, the temporary daubing ends.

Any symbols in the trigger column that are already daubed prior to calling of the bonus trigger symbol may remain daubed when the temporary daubing of the trigger column ends. In addition, any symbols in the trigger column that are called while the temporary daubing is in effect may remain daubed on the strip when the temporary daubing of the trigger column ends.

### VII. Example Networked Bingo Architecture

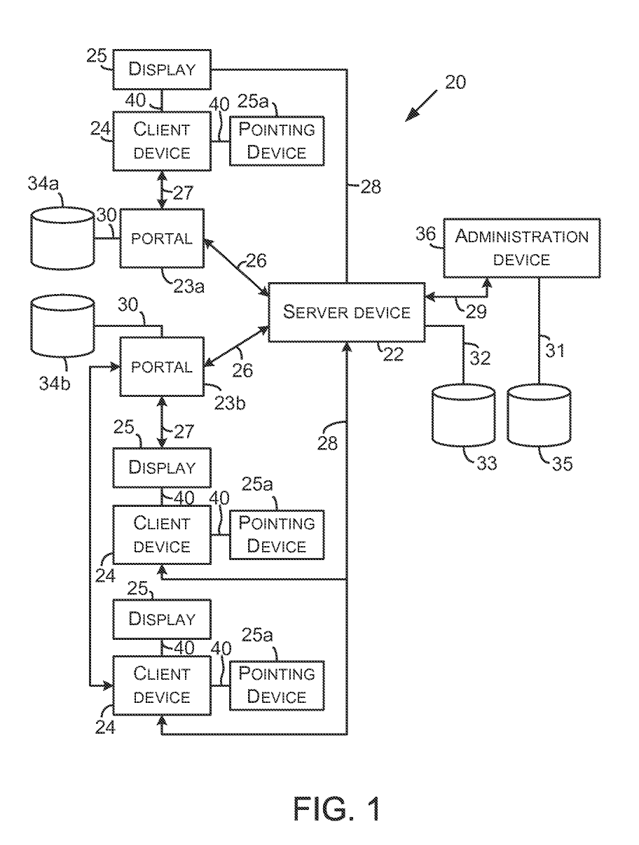

Networked bingo may be facilitated through the interconnection of computers and computer networks arranged to facilitate such game play. FIG. 1 depicts an example of such an arrangement. It should be understood, however, that this and other arrangements and processes described herein are set forth for purposes of example only, and other arrangements and elements (e.g., machines, interfaces, functions, orders of elements, etc.) can be added or used instead, and some elements may be omitted altogether. Further, as in most communication architectures, those skilled in the art will appreciate that many of the elements described herein are functional entities that may be implemented as discrete components or in conjunction with other components, in any suitable combination and location.

In FIG. 1, system 20 includes a server device 22, a number of databases 33, 34a, 34b, 35, an administration device 36, and a number of portals 23a, 23b, preferably in the form of World Wide Web (WWW) sites. In this embodiment, each of the portals 23a, 23b may include an online bingo room hosted on a corresponding bingo web server (not shown). Furthermore, each of the portals 23a, 23b may be accessible by a would-be bingo player (not shown) using a client device 24 having a display 25 and an associated pointing device 25a, such as a mouse or, alternatively, a touchpad.

In this embodiment the online bingo portal 23a is shown as having one client device 24 logically connected thereto, whereas bingo portal 23b is shown as being logically connected to two client devices 24. It will be appreciated by those skilled in the art that such an online bingo portal 23a, 23b can be logically connected to any number of such client devices 24 simultaneously.

Server device 22, databases 33, 34a, 34b, 35, bingo portal web servers (not shown) corresponding to the bingo portal 23a, 23b, client devices 24 and administration device 36 are capable of communicating with each other by means of communication networks 26, 27, 28, 29, 30, 31 and 32. Communication networks 26, 27, 28, 29, 30, 31 and 32 may be public Internet Protocol (IP) networks such as the Internet, or private IP networks, or public or private networks that operate according to other communication protocols. Furthermore, communication networks 26, 27, 28, 29, 30, 31 and 32 may be purpose-built or hardcoded networks designed for the support of networked bingo. For example, server device 22 may be a mainframe computer and client devices 24 may be so-called “dumb terminals” that only communicate with server device 22. Thus, communication networks 26, 27, 28, 29, 30, 31 and 32 may only include communication links between the devices they connect.

Client devices 24, server device 22, databases 33, 34a, 34b, 35, and administration device 36 may include various computing technologies, such as those that are semiconductor-based, magnetic, optical, acoustic, or biological in nature, any combination of these computing technologies, or any other technology known today or developed in the future, that can be used in conjunction with computational devices. The devices shown in FIG. 1 can be configured to generate, provide, receive, store, or display enhanced bingo strips for networked bingo matches.

A networked bingo architecture may also be defined to include more or fewer elements. For example, server device 22 and database 33 may be combined into the same physical or logical device, or each distributed across more than one physical or logical device. Two or more other devices of system 20 can be combined as well.

A. Example Server Device

Server device 22 may include a computing device with input, output, processing, storage, and memory functions. Server device 22 may be a form of personal computer, or may be physically designed for server operation. For example, server device 22 may be a rack-mounted or blade server component.

Server device 22 preferably includes at least one computer-readable processor (or more simply “processor”), one or more banks of memory, and computer-readable program instructions stored in the memory and executable by the processor to carry out functions described herein. The computer-readable program instructions may be more simply be referred to as “program instructions,” “software instructions,” “computer instructions,” or “program.” Server device 22 can include a user interface to perform at least some of the input and output functions.

For purposes of this description, a processor, such as a processor in server device 22, can comprise one or more general purpose processors (e.g., INTEL single core microprocessors or INTEL multicore microprocessors) or one or more special purpose processors (e.g., digital signal processors). A processor can be configured to execute program instructions stored in a memory. For purposes of this description, a bank of memory or a memory, such as a memory of server device 22, can comprise a non-transitory computer-readable storage medium readable by a processor. Each non-transitory computer-readable storage medium can comprise volatile and/or non-volatile storage components, such as optical, magnetic, organic or other memory or disc storage, which can be integrated in whole or in part with a processor. A bank of memory or a memory can be referred to as a “data storage device” or more simply, “data storage.”

With respect to the depiction of server device 22 in FIG. 1, server device 22 may actually take the form of multiple physical components or computers that are co-located or distributed. For example, server device 22 may be a cluster of computing devices that operate in conjunction with one another to enable networked bingo matches. This cluster may be in a particular physical location, such as an Internet service provider (ISP), or may operate over a network to coordinate server functions.

Server device 22 may run a standalone or distributed operating system to enable server functions. This operating system may be based on Microsoft Windows, Apple's MacOS, Linux, FreeBSD or various other technologies. These operating systems preferably support multiple processes or threads of execution so that a single server device 22 can support a potentially large number of networked bingo matches simultaneously.

Server device 22 preferably operates under control of a server-stored program (not shown) capable of enabling multiple players (e.g., all players) accessing a bingo portal 23a, 23b by a client device 24 to participate in one or more games of networked bingo. The server-stored program provides a discrimination means in the form of computer instructions configured to be executed by a processor to determine a winner or winners of a networked bingo match. The stored program in server device 22 (e.g., in a memory of server device 22) may also maintain a dynamic register of all players admitted to, and actively participating in, a networked bingo match, together with data representative of a corresponding bingo portal 23a, 23b through which each participating player may access a networked bingo game.

Server device 22 can also include a communication interface that provides for transmitting communications to or over a communication network and that provides for receiving communications from or over a communication network. A network connection, provided by the communication interface, can take the form of a wireline connection, such as an Ethernet, cable modem, digital subscriber line, or T1 carrier connection. Additionally or alternatively, the network connection can take the form of a local area or wide area wireless connection, such as IEEE 802.11 (Wifi), Code Division Multiple Access (CDMA), Global System for Mobile communications (GSM), or Worldwide Interoperability for Microwave Access (WIMAX). However, other forms of physical layer connections and other types of standard or proprietary communication protocols may be used.

Server device 22 can include a system bus, network, or other connection mechanism that connects or otherwise links two or more of the processor, the memory, the user interface and the communication interface that make up a least a portion of server device 22.

B. Example Database

Database 33 is preferably coupled to server device 22, and stores networked bingo game information. Database 33 is either a standalone component, as shown in FIG. 1, or it may be combined with server device 22. Database 33 may contain profile data for players of a networked bingo match. This profile data may include a player's identification and means for authenticating and authorizing the player, such as a username and password. The profile data may also include information pertinent to a networked bingo match, such as any bingo tickets or strips associated with the player, as well as a bonus-counter symbol counter associated with the player. The profile data may additionally include other information that an operator of a networked bingo game might find useful to store, such as the player's means of payment (e.g., credit card information or bank account information), win/loss record, historical wagering data, a “friends list” of other players, and so on.

Database 35 is preferably coupled to administrative device 36. Database 34a is preferably coupled to portal 23a. Database 34b is preferably coupled to portal 23b. Databases 34a, 34b, and 35 can be standalone components, as shown in FIG. 1, or can be combined with portal 23a, portal 23b, administrative device 36, respectively. Database 35 can store data pertaining to server device 22 or one or more other server devices (not shown) in system 20. Databases 34a, 34b can store data pertaining to portals 23a, 23b, respectively.

Databases 33, 34a, 34b, 35 may be facilitated by database software, such as that from Oracle Corporation, MySQL AB, or the PostgreSQL free software. Furthermore, databases 33, 34a, 34b, 35 may operate across multiple physical devices in a clustered mode. However, databases 33, 34a, 34b, 35 need not be a database in the traditional sense, and may instead include one or more flat text files, or some other means of storing and retrieving profile data.

C. Example Client Devices

Client devices 24 may include a personal computer, laptop computer, a wireless communication device such as a cell phone, a personal digital assistant, a computer terminal, or a similar device. Client devices 24 preferably include at least one processor, one or more banks of memory, and program instructions stored in the memory and executable by the processor to carry out functions described herein. Furthermore, client devices 24 may operate under an operating system such as Microsoft Windows, Apple MacOS, Linux or FreeBSD, and are preferably provisioned with a web browser and network connection. Client device can include a user interface having a display 24 and a pointing device 25a.

Client devices 24 can include a communication interface that provides for transmitting communications to or over a communication network and that provides for receiving communications from or over a communication network. A network connection, provided by the communication interface, can take the form of a wireline connection, such as an Ethernet, cable modem, digital subscriber line, or T1 carrier connection. Additionally or alternatively, the network connection can take the form of a local area or wide area wireless connection, such as IEEE 802.11 (Wifi), CDMA, GSM, or WIMAX. However, other forms of physical layer connections and other types of standard or proprietary communication protocols may be used.

Client devices 24 can include a system bus, network, or other connection mechanism 40 that connects or otherwise links two or more of the processor, the memory, the user interface and the communication interface that make up at least a portion of a client device 24.

Using client device 24, networked bingo may be facilitated by a client process (not shown) that executes on client device 24, and the server-stored program (not shown), or server process, that executes on server device 22. In order to play a networked bingo match from any client device 24, a client process (not shown) may first be downloaded, for example, from server device 22 or bingo portal 23a, 23b to client device 24. The downloaded client process (not shown) may then be installed in client device 24, where after it is ready for execution. Alternatively, the client process (not shown) executes from within a WWW browser of client device 24, and is loaded from the player's bingo portal 23a, 23b, WWW server (not shown) by the client device's 24 WWW browser. In either case, once the client process (not shown) is launched, communication between client device 24 and server device 22 then proceeds.

In a distributed topology, the client process (not shown) on the player's client device 24 may be functionally identical, irrespective of which online bingo portal 23a, 23b a player selects to access a networked bingo match. The output functions of client devices 24 may include a graphical user interface (GUI) rendered on display 25. Such a GUI may represent networked bingo match information in some combination of graphics and text. For example, a GUI on display 25 may represent a bingo ticket associated with client device 24, and include options to perform the acts of providing a form of payment, purchasing a bingo strip, and/or cashing out a balance of funds or a prize. The client process executing on client device 24 will typically display different trademarks, color schemes, or “look and feel” depending on which online bingo portal 23a, 23b was selected by the player.

D. Example Administration Facilities

System 20 further includes administration device 36, preferably in the form of an application server coupled to server device 22 using communication network 29. Administration device 36 may be used by operators of networked bingo games to monitor the status of client devices 24, server device 22, and database 33. Additionally, operators of networked bingo games may use an administration device to monitor, collect, or repair the status of players or matches. For example, an administration device may allow an operator to view the number of players in a networked bingo match, the amount of money being wagered in the match, size of a progressive prize, and so on. Additionally, administration device 36 preferably settles the wagers of the participating players after the completion of each iteration of a networked bingo match. Administrative device 36 can include a processor, a memory, a user interface, and a communication interface, all of which can be linked together via a system bus, network, or other connection mechanism.

E. Example Networked Bingo Operators

Operators of networked bingo matches are not shown in FIG. 1. These operators may be individuals, groups, corporations, or other business or non-business entities that operate networked bingo games for entertainment, profit or other purposes. Multiple operators may operate networked bingo games on the same physical devices, or may own or have dedicated access to certain devices. Furthermore, devices operated by different operators may be networked to allow distributed networked bingo matches, thus expanding the reach of an operator to include players that may not have a business relationship with the operator.

### VIII. Example Networked Bingo Match Play

Using client device 24, a networked bingo match may be facilitated by a client process (not shown) that executes on client device 24, and the server-stored program (not shown), or server process, that executes on server device 22. The server process (not shown) may generate random events representing a “called” symbol. The client process obtains the result of each random event from server device 22, across the communication network 28, and marks any grid position on a player's bingo tickets or strips that is associated with the same symbol as that of the “called” symbol. The client process displays a representation the player's bingo ticket or strips on the display 25 of client device 24 with any marked off grid positions being discernible on the bingo tickets. A single client device 24 (executing the client process) may be used by more than one human player, a human player may use more than one client device 24.

Each of the methods described herein are for purposes of example. In each method, more or fewer functions may be used, and the functions may be carried out in a different order than is illustrated in the figures or described herein. Additionally, two or more of these methods may be combined with one another in multiple arrangements. However, preferred embodiments are not limited to these methods or any combination of these methods.

A. Example Registration and Payment

An operator of networked bingo matches may require a client device 24 to register and/or provide payment for networked bingo match services prior to allowing client device 24 to participate in these networked bingo match services.

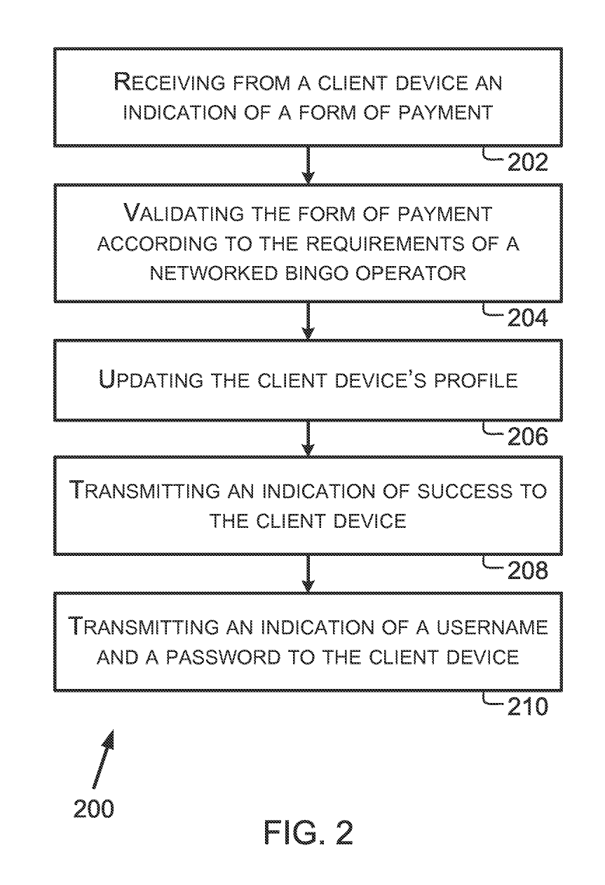

FIG. 2 is a flowchart depicting a set of functions 200 (or more simply “the set 200”) that can be carried out in accordance with one or more example embodiments described herein. The set 200 includes the functions shown in blocks labeled with even numbers 202 through 210, inclusive. A variety of methods can be performed using one or more of the functions shown in set 200 and one or more other functions described herein. The set 200 depicts an example registration and payment process that can be carried out using server device 22 and client device 24.

Block 202 includes receiving, by server device 22 from client device 24, an indication of a form of payment. Acceptable forms of payment can include, but are not limited to, a credit card, a debit card, or bank account information, as well as other methods of facilitating traditional or electronic payments. Next, block 204 includes validating, by server device 22, the form of payment according to the requirements of an operator of networked bingo. This validation may include transactions between server device 22, database 33, and third-party payment verification services that are not represented in FIG. 1.

Assuming that the form of payment is properly validated, block 206 includes updating, by server device 22, the profile of client device 24 in the database 33. This update may include adding a representation of the form of payment to the profile of client device 24 in the database 33, updating the amount or type of funds available to client device 24, or other actions. Next, block 208 includes transmitting, by server device 22, an indication of success to client device 24. Client device 24 may responsively display an indication of success on an output peripheral, such as display 25.

Next, block 210 includes transmitting an indication of a username and password to client device 24. This transmission can occur by server device 22 and over a communication network. This transmission function would preferably occur when a new networked bingo account is being provisioned on behalf of client device 24. Client device 24 may then, and as needed, use the username and password to log on to server device 22 and participate in networked bingo.

B. Example Bingo Strip Generation and Distribution

Preferably, server device 22 generates and distributes bingo strips for networked bingo matches. As described herein, these bingo strips may be computerized (e.g., computer-readable) representations of bingo strips that are generated and stored for later use, or may be generated in real time, as needed. Thus, the generation of bingo strips at server device 22 may be triggered by one or more networked bingo match events or may occur asynchronously to client device 24 and match activities. For example, client device 24 may request a bingo strip and server device 22 may dynamically generate a new bingo strip in response to the request, or server device 22 may, from time to time, generate a number of new bingo strips and then store these bingo strips in a memory for later use.

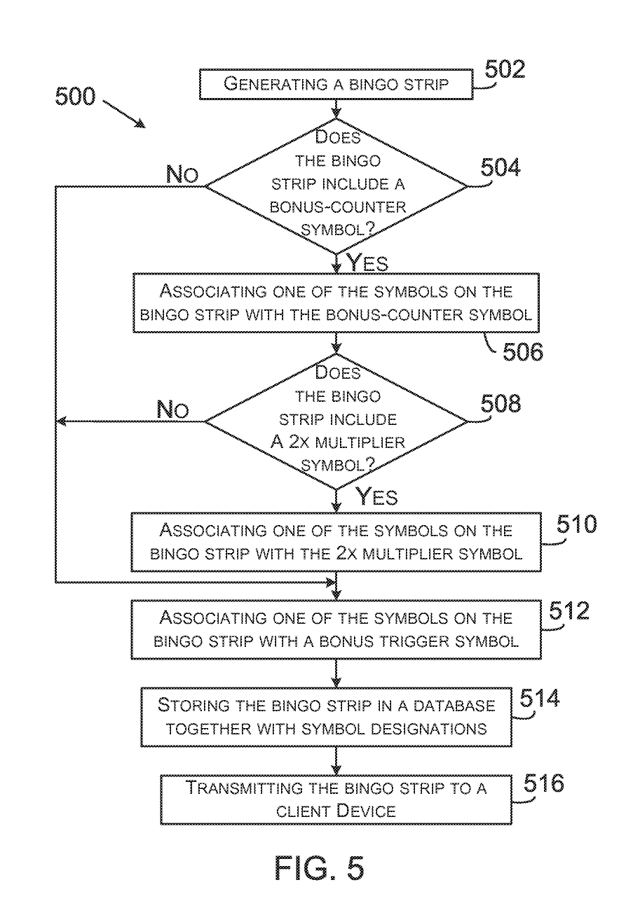

FIG. 5 is a flowchart depicting a set of functions 500 (or more simply “the set 500”) that can be carried out in accordance with one or more example embodiments described herein. The set 500 includes the functions shown in blocks labeled with even numbers 502 through 516, inclusive. A variety of methods can be performed using one or more of the functions shown in set 500 and one or more other functions described herein. The set 500 depicts an example process generating and distributing bingo strips using server device 22 and other elements of system 20. The bingo strip can include a computer-readable bingo strip.

Block 502 includes generating, by server device 22, a bingo strip (e.g., one or more bingo strips). Generating the bingo strip can include selecting a quantity of symbols from symbol set 416 for the bingo strip. As an example, the quantity of selected symbols could equal 15 symbols or another quantity of symbols, and the remaining symbols on the bingo strip can be free space symbols. Server device 22 can use a random number generator to select the symbols. Generating the bingo strip can include selecting a grid position for each symbol of the selected symbols and a grid position for each free space symbol. Table 1 includes example symbols selected from symbol set 416 for a bingo strip with 27 grid positions, such as bingo ticket 302. “FS” represents a free space symbol.

TABLE 1

| | | | | | | | | |
|---|---|---|---|---|---|---|---|---|
| FS | 45 | FS | 6 | 77 | FS | 38 | 4 | FS |
| FS | 18 | FS | FS | 15 | 82 | 55 | FS | 57 |
| 1 | FS | FS | 69 | FS | 44 | 16 | 88 | FS |

Generating the bingo strip can include storing a symbol identifier for the selected symbol and an associated grid position identifier. The data stored for the generating bingo ticket 302 can be configured in various configurations. As an example, the stored data can be stored in a configuration of (symbol identifier, grid position). In that case, for bingo ticket 302, the stored Data can be configured as: (FS, 1), (45, 2), (FS, 3), (6, 4), (77, 5), (FS, 6), (38, 7), (4, 8), (FS, 9), (FS, 10), (18, 11), (FS, 12), (FS, 13), (15, 14), (82, 15), (55, 16), (FS, 17), (57, 18), (1, 19), (FS, 20), (FS, 21), (69, 22), (FS, 23), (44, 24), (16, 25), (88, 26), (FS, 27). Other examples configurations for storing data representing the selected symbol and an associated grid position are also possible.

Next, block 504 includes determining, by server device 22, whether or not the bingo strip is to include a bonus-counter symbol. Server device 22 can use a process that randomly selects a bingo strip to include a bonus-counter symbol. If the bingo strip is not selected to include a bonus-counter symbol, such that server device 22 determines the bingo strip does not include the bonus-counter symbol, the set 500 can continue at block 512. If the bingo strip is selected to include a bonus-counter symbol, such that server device determines the bingo strip is to include the bonus-counter symbol, the set can continue at block 506.

Next, block 506 includes associating, by server device 22, one of the symbols on the bingo strip with the bonus-counter symbol. As an example, a symbol on the bingo strip selected from symbol set 416 is designated or selected to be associated with the bonus-counter symbol. Alternatively, a free space symbol on the bingo strip could be associated with the bonus-counter symbol. Server device 22 can use a process that randomly selects one of symbols selected from symbol set 416 for the bingo strip to be associated with the bonus-counter symbol. As an example, server device 22 can select symbol 44 at grid position 24 to be associated with the bonus-counter symbol. Table 2 includes example symbols selected from symbol set 416 for the bingo strip including data “M” representing symbol “44” is associated with the bonus-counter symbol.

TABLE 2

| | | | | | | | | |
|---|---|---|---|---|---|---|---|---|
| FS | 45 | FS | 6 | 77 | FS | 38 | 4 | FS |
| FS | 18 | FS | FS | 15 | 82 | 55 | FS | 57 |
| 1 | FS | FS | 69 | FS | 44/M | 16 | 88 | FS |

The data stored for the generating bingo ticket 302, wherein bingo strip is selected to include the bonus-counter symbol, can be configured in various configurations. As an example, the stored data can be stored in a configuration of (symbol identifier, grid position, extra symbol (if any)). In that case, for bingo ticket 302, the stored data can be configured as: (FS, 1), (45, 2), (FS, 3), (6, 4), (77, 5), (FS, 6), (38, 7), (4, 8), (FS, 9), (FS, 10), (18, 11), (FS, 12), (FS, 13), (15, 14), (82, 15), (55, 16), (FS, 17), (57, 18), (1, 19), (FS, 20), (FS, 21), (69, 22), (FS, 23), (44, 24, M), (16, 25), (88, 26), (FS, 27). Other examples configurations for storing data representing the selected symbol and an associated grid position and extra symbol are also possible.

Next, block 508 includes determining, by server device 22, whether or not the bingo strip is to include a 2× multiplier symbol. Server device 22 can use a process that randomly selects a bingo strip to include a 2× multiplier symbol. If the bingo strip is not selected to include a 2× multiplier symbol, such that server device 22 determines the bingo strip does not include the 2× multiplier symbol, the set 500 can continue at block 512. If the bingo strip is selected to include a 2× multiplier symbol, such that server device determines the bingo strip is to include the 2× multiplier symbol, the set can continue at block 510. A person having ordinary skill in the art will understand that multiplier values other than 2× (e.g., 3×, 4×, 5×, etc.) can be used in place of the described 2× multiplier value.

Next block 510 includes associating, by server device 22, one of the symbols on the bingo strip with the 2× multiplier symbol. As an example, a symbol on the bingo strip selected from symbol set 416 is designated or selected to be associated with the 2× multiplier symbol. The symbol selected to be associated with the 2× multiplier symbol is preferably different than the symbol selected to be associated with the bonus-counter symbol, and can be one of the symbols selected from symbol set 416. Alternatively, a free space symbol on the bingo strip or the symbol associated with the bonus-counter symbol could be associated with the 2× multiplier symbol. Server device 22 can use a process that randomly selects one of the symbols (other than the symbol selected to be associated with the multiplier symbol) selected from symbol set 416 for the bingo strip to be associated with the 2× multiplier symbol. As an example, server device 22 can select symbol 18 at grid position 11 to be associated with the 2× multiplier symbol. Table 3 includes example symbols selected from symbol set 416 for the bingo strip including data “X” representing symbol “18” is associated with the 2× multiplier symbol.

TABLE 3

| | | | | | | | | |
|---|---|---|---|---|---|---|---|---|
| FS | 45 | FS | 6 | 77 | FS | 38 | 4 | FS |
| FS | 18/X | FS | FS | 15 | 82 | 55 | FS | 57 |
| 1 | FS | FS | 69 | FS | 44/M | 16 | 88 | FS |

The data stored for the generating bingo ticket 302, wherein bingo strip is selected to include the bonus-counter symbol and the 2× multiplier symbol, can be configured in various configurations. As an example, the stored data can be stored in a configuration of (symbol identifier, grid position, extra symbol (if any)). In that case, for bingo ticket 302, the stored data can be configured as: (FS, 1), (45, 2), (FS, 3), (6, 4), (77, 5), (FS, 6), (38, 7), (4, 8), (FS, 9), (FS, 10), (18, 11, X), (FS, 12), (FS, 13), (15, 14), (82, 15), (55, 16), (FS, 17), (57, 18), (1, 19), (FS, 20), (FS, 21), (69, 22), (FS, 23), (44, 24, M), (16, 25), (88, 26), (FS, 27). Other examples configurations for storing data representing the selected symbol and an associated grid position and extra symbols are also possible.

Next, block 512 includes associating, by server device 22, one of the symbols on the bingo strip with a bonus trigger symbol. As an example, a symbol on the bingo strip selected from symbol set 416 is designated or selected to be associated with the bonus trigger symbol. The symbol selected to be associated with the bonus trigger symbol is preferably different than the symbol(s) selected to be associated with the bonus-counter symbol or the 2× multiplier symbol, and can be one of the symbols selected from symbol set 416. Alternatively, a free space symbol on the bingo strip or the symbol associated with the bonus-counter symbol or the 2× multiplier could be associated with the bonus trigger symbol. Server device 22 can use a process that randomly selects one of the symbols (other than the symbol(s) selected to be associated with the multiplier symbol or the 2× multiplier symbol) selected from symbol set 416 for the bingo strip to be associated with the bonus trigger symbol. As an example, server device 22 can select symbol 57 at grid position 18 to be associated with the bonus trigger symbol. Table 4 includes example symbols selected from symbol set 416 for the bingo strip including data “B” representing symbol “57” is associated with the bonus trigger symbol.

TABLE 4

| | | | | | | | | |
|---|---|---|---|---|---|---|---|---|
| FS | 45 | FS | 6 | 77 | FS | 38 | 4 | FS |
| FS | 18/X | FS | FS | 15 | 82 | 55 | FS | 57/B |
| 1 | FS | FS | 69 | FS | 44/M | 16 | 88 | FS |

The data stored for the generating bingo ticket 302, wherein bingo strip is selected to include the bonus-counter symbol, the 2× multiplier symbol, and the bonus trigger symbol, can be configured in various configurations. As an example, the stored data can be stored in a configuration of (symbol identifier, grid position, extra symbol (if any)). In that case, for bingo ticket 302, the stored data can be configured as: (FS, 1), (45, 2), (FS, 3), (6, 4), (77, 5), (FS, 6), (38, 7), (4, 8), (FS, 9), (FS, 10), (18, 11, X), (FS, 12), (FS, 13), (15, 14), (82, 15), (55, 16), (FS, 17), (57, 18, B), (1, 19), (FS, 20), (FS, 21), (69, 22), (FS, 23), (44, 24, M), (16, 25), (88, 26), (FS, 27). Other examples configurations for storing data representing the selected symbol and an associated grid position and extra symbols are also possible. Although bingo ticket 302 is shown with a multiplier symbol, a bonus-counter symbol and a bonus trigger symbol, a randomly-generated strip may include only one or two of those extra symbols, or none at all.

Next, block 514 includes storing the bingo strip in a database (e.g., database 33 or other memory) together with any extra symbols selected for the bingo strip, namely the bonus-counter symbol, the 2× multiplier symbol, or the bonus trigger symbol. Storing the bingo strip and the symbols selected for the bingo strip including any extra symbols can include storing a symbol designation or identifier for the selected symbols. If the bingo strip is associated with a client device 24, the database or other memory can store the bingo strip in a profile that is associated with client device 24. If the bingo strip is not associated with a client device, the database or other memory can store the bingo strip for future retrieval and associating with a client device.

Next, block 516 includes transmitting, by server device 22, the bingo strip to a client device 24. The communication interface of server device 22 can transmit the bingo strip onto the communication network for transmission, in turn, to the client device.

Although the set 500 is described with respect to server device 22 generating and distributing bingo strips, another component such as portal 23a or 23b or administration device 36 can be configured to perform the set 500 or any function thereof. In at least some example embodiments, the set 500 can be performed without performing the functionality of block 512.

Any changes to a bingo strip or bingo ticket as a result of performing any function of the set 500 can cause server device 22 to modify the bingo strip or ticket stored in the memory, such as database 33, and to transmit, to the client device 24 displaying the bingo strip or bingo ticket, data to modify the data stored at the client device for displaying the iterations of the networked bingo match.

C. Example Iterations of a Networked Bingo Match

An iteration of a networked bingo match includes a new symbol being “called” (i.e., selected) and each bingo ticket or bingo strip competing in the networked bingo match being checked to determine if the bingo tickets or bingo strips contain the new symbol. For a bingo strip that contains the new symbol, server device 22 may perform additional sets of determinations and steps. These steps may include altering the status of the client devices 24 based on the new symbol having pre-defined designations, affecting either client device 24 itself, or global designations affecting all the client devices.

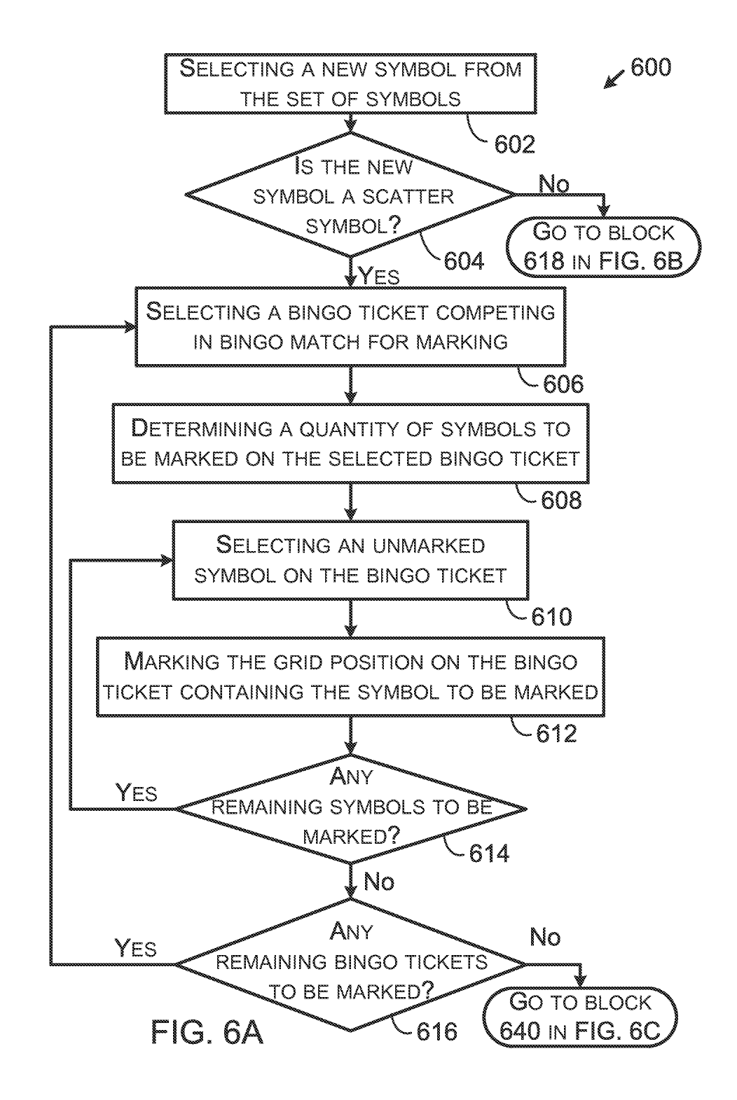

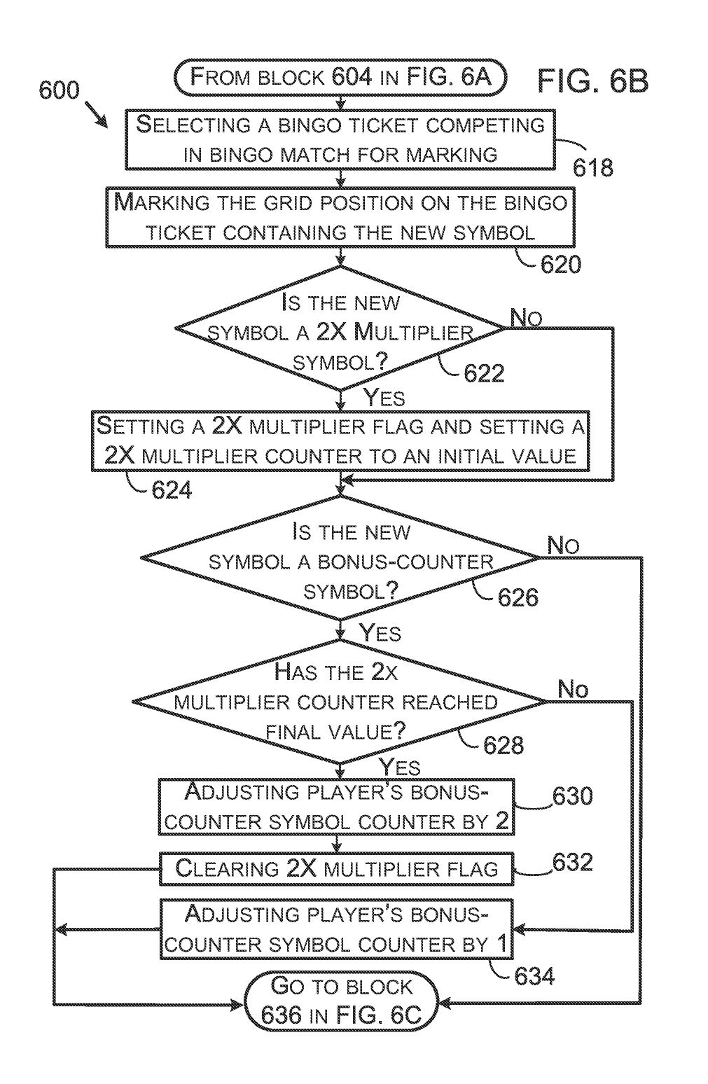

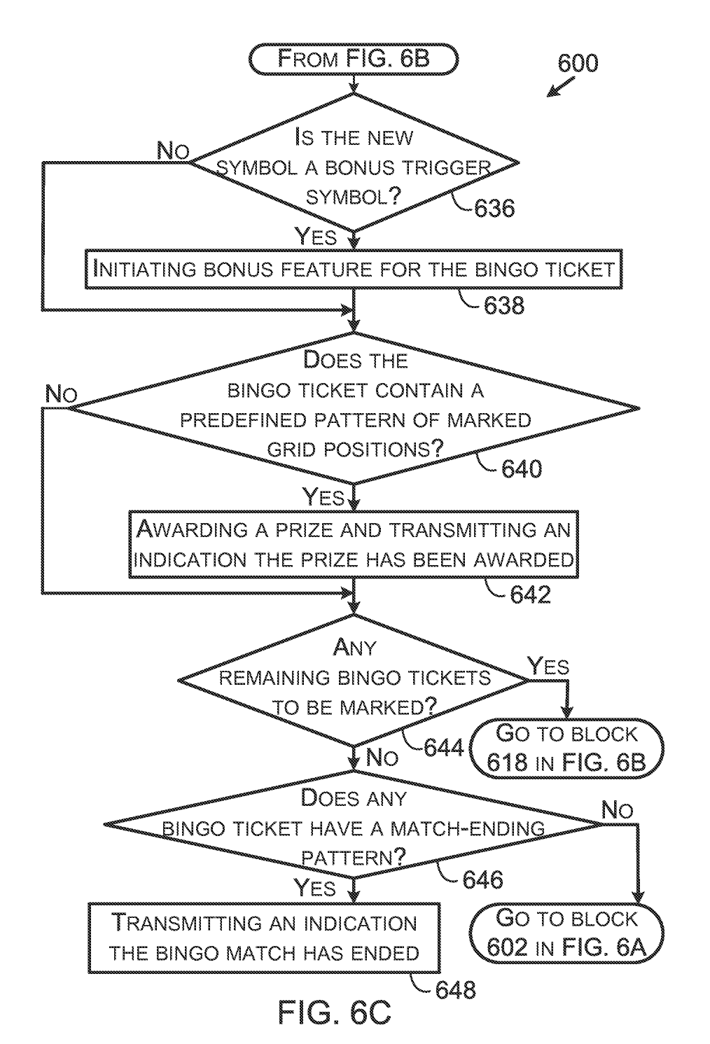

Next, FIG. 6A, FIG. 6B, and FIG. 6C are flowcharts depicting a set of functions 600 (or more simply “the set 600”) that can be carried out in accordance with one or more example embodiments described herein. The set 600 includes the functions shown in blocks labeled with even numbers 602 through 648, inclusive, and in five “Go to” blocks. A variety of methods can be performed using one or more of the functions shown in set 600 and one or more other functions described herein. The set 600 depicts an example process pertaining to performing an iteration as part of a networked bingo match. The devices described in this section as performing any part of a function of the set 600 can do so, at least in part, by a processor of that device executing software program instructions.

Block 602 includes selecting, by server device 22, a new symbol from the set of symbols 400. Selecting the new symbol may be performed with or without replacement. Server device 22 can use a random selection process to select the new symbol.

Next block 604 includes determining, by server device 22, whether the new symbol is a scatter symbol 406. In other words, sever device 22 determines whether the new symbol has a global designation that affects all bingo tickets or bingo strips competing in the networked bingo game and all client devices provided with at least one of those bingo tickets or bingo strips. In that regard, scatter symbol 406 can be referred to as a global-designation symbol that is selectable for marking symbols on a bingo ticket, but that does not appear within any grid position on the bingo ticket, or more simply, a global-designation symbol. Determining whether the new symbol is the scatter symbol 406 can include server device 22 determining that the random number selected at block 602 is not associated with the scatter symbol. For example, for a 90-symbol bingo match, if the scatter symbol is associated with the number 0 or 91, then server device can determine that the new symbol is not the scatter symbol if the selected random number is between 1 and 90, inclusive. Of course, if the selected random number is 0 or 91 for that example, then server device 22 can determine that the new symbol is the scatter symbol. If server device 22 determines that the new symbol is not the scatter symbol, then the set 600 continues at the Go To Block 618 in FIG. 6B, otherwise, the set 600 continues at block 606. In response to determining the new symbol is the scatter symbol, server device 22 can prepare to mark symbols on the bingo tickets or bingo strips. That preparation can include, but is not limited, to providing a memory, such as database 33, with memory indicating the scatter symbol was selected. That preparation can also include setting an iteration flag associated with each bingo ticket competing in the bingo match to an unmarked-for-iteration setting. Upon marking any bingo ticket for an iteration of the bingo match or at least checking the bingo ticket to determine that the bingo ticket is not to be marked for the iteration, server device 22 can cause the memory storing the iteration flag for that bingo ticket to a marked-for-iteration setting.

Next block 606 includes selecting, by server device 22, a bingo ticket competing in the networked bingo match for marking. As an example, if 30 players, including the 6 players associated with the player profiles identifiers shown in Table 5 below, have been provided with provided with a respective bingo ticket for the bingo match, selecting the bingo ticket can include selecting the bingo ticket provided to the player associated with player profile ID 005. Upon returning to block 606 from block 616 (discussed below), server device 22 can select another bingo ticket for marking, such as the bingo ticket provided to a player associated with one of the other five player profile identifiers. Server device 22 is not limited to marking a single bingo ticket at any one time, but can be configured to mark multiple competing bingo tickets simultaneously. Selecting a bingo ticket can include transmitting the bingo ticket from a memory, such as database 33, to a processor within server device 22. Selecting a bingo ticket can include server device 22 determining that the bingo ticket has not already been marked for a current iteration of the bingo match.

Next block 608 includes determining, by server device 22, a quantity of symbols to be marked on the selected bingo ticket (or bingo strip), in response to the new selected symbol being the scatter symbol. Server device 22 can use a random selection process to select a number to be used as the quantity of symbols to be marked on the selected bingo ticket, or in other words, to select the quantity of symbols to be marked on the selected bingo ticket. Alternatively, the selected number can be predefined. Server device 22 can set a mark-for-scatter-symbol counter within a memory, such as database 33, to track whether any unmarked symbols remain to be marked in response to selection of the scatter symbol.

As an example, the selected number can be 1 or 2, such that the quantity of symbols to be marked is 1 or 2, respectively. The selected number could be greater than 2, such as 3, 4, 5, etc., especially, for networked bingo matches using a relatively larger set of selectable symbols compared to networked bingo matches using a relatively smaller set of selectable symbols. Server device 22 can perform a single selection of the number of symbols to be marked for all bingo tickets competing in the bingo match. In this way, all bingo strips have the same number of unmarked symbols marked in response to selection of the scatter symbol. Alternatively, server device 22 can perform multiple selections of a number of symbols to be marked, such as a separate selection of a number to be used for marking each respective bingo ticket competing in the bingo match. In this way, two or more bingo strips may have a different quantity of unmarked symbols marked in response to selection of the scatter symbol.

Next block 610 includes selecting, by server device 22, an unmarked symbol on the bingo ticket (or bingo strip). Server device 22 can use a random selection process to select the unmarked symbol. Server device 22 can refer to data indicating which symbols or grid positions are unmarked, such as the data shown in Table 4 below, to determine which symbols (e.g., 45, 6, 77, 38, 4, 18, 15, 82, 57, 69, 44, 88) or grid positions (2, 4, 5, 7, 8, 11, 12, 13, 18, 22, 24, 26) are unmarked. The random selection process can include selecting a number within one of those unmarked symbols or grid positions.

Selecting an unmarked symbol can be part of a process server device 22 uses to prepare to mark a quantity of symbols on the bingo ticket. Selecting the unmarked symbol or grid position can be conditioned on the symbol not being associated with an extra symbol or the grid position including an extra symbol with the unmarked symbol. For example, server device 22 can be configured so that the randomly selected symbol is not a symbol that is associated with a bonus-counter symbol, a multiplier symbol, or a bonus trigger symbol. In this regard, symbols 18, 57, and 44, associated with an extra on the example bingo ticket 302, would not be selected for marking in response to selection of the scatter symbol. Alternatively, server device 22 can be configured to include any symbol associated with an extra symbol as a symbol selectable for marking in response to selection of the scatter symbol. The preparation process performed by server device 22 can include other functions as well.

Next block 612 includes marking, by server device 22, the grid position on the bingo ticket containing the symbol to be marked. Marking the grid position can include marking the symbol or symbols within the grid position. Marking the grid position can include modifying the bingo ticket or bingo strip stored in a memory, such as database 33, to include an indicator or other data that the grid position or symbol(s) therein is marked. The data in Table 6 below shows an example of grid positions or symbols marked with an indicator “Y” to indicate the grid position or symbols therein are marked.

Next block 614 includes determining, by server device 22, whether any remaining symbols (of the quantity of symbols selected at block 608) are to be marked. If at least one more unmarked symbol on the bingo ticket remains to be marked in response to selection of the scatter symbol, the set 600 can continue at block 610, otherwise, the set 600 can continue at block 616. Server device 22 can refer to a mark-for-scatter-symbol counter to make the determination of block 614.

Next block 616 includes determining, by server device 22, whether any remaining bingo tickets competing in the networked bingo match remain to be marked, in response to the new selected symbol being the scatter symbol. If at least one more bingo ticket remains to be marked in response to selection of the scatter symbol, the set 600 can continue at block 606, otherwise, the set 600 can continue at Go To Block 640 in FIG. 6C block. Server device 22 can refer to the iteration flag associated with each bingo ticket to determine whether any of the competing bingo strips remain to be marked in response to selection of the scatter symbol.

Next, block 618 includes selecting, by server device 22, a bingo ticket (or bingo strip) competing in the networked bingo match for marking. The example of selecting a bingo ticket provided in the description of block 606 is applicable to block 618. Upon returning to block 618 from block 644 (discussed below), server device 22 can select another bingo ticket for marking, such as the bingo ticket provided to a player associated with one of the other five player profile identifiers described in the block 606 example. Server device 22 is not limited to marking a single bingo ticket at any one time, but can be configured to mark multiple competing bingo tickets simultaneously. Selecting a bingo ticket can include transmitting the bingo ticket from a memory, such as database 33, to a processor within server device 22. Selecting a bingo ticket can include server device 22 determining that the bingo ticket has not already been marked for a current iteration of the bingo match.

Next, block 620 includes marking, by server device 22, the grid position on the bingo ticket (or bingo strip) containing the new symbol. Marking the grid position can include marking the symbol or symbols within the grid position. Marking the grid position can include modifying the bingo ticket or bingo strip stored in a memory, such as database 33, to include an indicator or other data that the grid position or symbol(s) therein is marked. The data in Table 6 shows an example of grid positions or symbols marked with an indicator “Y” to indicate the grid position or symbols therein are marked.

Next, block 622 includes determining, by server device 22, whether the new symbol is a 2× multiplier symbol (or a symbol associated with the 2× multiplier symbol or a multiplier value other than 2×). Determining whether the new symbol is the 2× multiplier symbol or a symbol associated with the 2× multiplier symbol can include server determining whether new symbol selected from symbol set 400 is associated with a multiplier symbol for the bingo ticket (selected at block 618). Referring to the example data shown in Table 6, server device 22 can make the determination of block 622 by determining whether the grid position containing the new symbol or the new symbol itself is selected with a multiplier symbol designator (e.g., “M” in Table 6). If the new symbol may not affect all bingo tickets competing in the match, that new symbol can be classified as having a local designation, which differs from the scatter symbol 406 having a global designation. If server device 22 determines that the new symbol is not a 2× or other multiplier symbol, the set 600 can continue at block 626. If server device 22 determines that the new symbol is a multiplier symbol, such as a 2× multiplier symbol, the set 600 can continue at block 624.

Next, block 624 includes setting, by server device 22, a 2× multiplier flag and setting a 2× multiplier counter to an initial value. The 2× multiplier flag and the 2× multiplier counter can be stored in a memory, such as database 33. If the new symbol has a multiplier value other than 2×, such as 3×, the stored multiplier flag can be referred to as the 3× multiplier flag, and the 2× multiplier counter can be referred to as the 3× multiplier flag. As an example, the initial value of the 2× multiplier counter can be 5 and a final value of the 2× multiplier counter can be 0, such that adjusting the counter can occur by decrementing the counter by 1 or another value. As another example, the initial value of the 2× multiplier counter can be 0 and a final value of the 2× multiplier counter can be 5, such that adjusting the counter can occur by incrementing the counter by 1 or another value. Both the 2× multiplier flag and the 2× multiplier counter are specific to the bingo strip. Server device 22 can be configured to select the initial value of a multiplier counter based on the value of the multiplier symbol. For instance, if the new symbol is a 3× multiplier symbol, the initial value of the multiplier symbol can be 3 instead of 5 for the 2× multiplier symbol, such that the player can win a larger multiplier, but has fewer iterations to win the larger multiplier.

Next, block 626 includes determining, by server device 22, whether the new symbol is a bonus-counter symbol (or is a symbol that is associated with the bonus-counter symbol). If server device 22 determines that the new symbol is not the bonus-counter symbol (or is not a symbol that is associated with the bonus-counter symbol) at block 626, the set 600 can continue at the Go To Block 636 in FIG. 6C block. If server device 22 determines that the new symbol is the bonus-counter symbol or a symbol associated with the bonus counter symbol, the set 600 can continue at block 628.

Next, block 628 includes determining, by server device 22, whether the 2× multiplier counter reached a final value. Server device 22 can refer to the 2× multiplier counter stored in the memory, such as database 33, to compare the value of the 2× multiplier symbol to a predefined final value, such as zero. If the 2× multiplier counter value has reached the final value, the set 600 can continue at block 630. If the 2× multiplier counter value has not reached the final value, the set 600 can continue at block 634.

Next, block 630 includes adjusting, by server device 22, a player's bonus-counter symbol counter by 2 (or other numeric value of the multiplier symbol, such as 3 for a 3× multiplier symbol). Adjusting the bonus-counter symbol counter can include decrementing the counter if the initial value is greater than the final value or incrementing the counter if the initial value is less than the final value.

Next, block 632 includes clearing, by server device 22, the 2× multiplier flag (or other multiplier flag, such as a 3× multiplier flag if the new symbol is (or is associated with) a 3× multiplier symbol).

Next, block 634 includes adjusting, by server device 22, the player's bonus-counter symbol counter by 1. Set 600 can continue at block 634 from block 628 if the 2× multiplier counter has not reached its final value. Adjusting the bonus-counter symbol counter by 1 can include decrementing the counter by 1 if the initial value is greater than the final value or incrementing the counter by 1 if the initial value is less than the final value. Adjusting the bonus-counter symbol counter can include storing the value of the adjusted bonus-counter symbol counter in a memory, such as database 33.

Next, block 636 includes determining, by server device 22, whether the new symbol is a bonus trigger symbol (or a symbol associated with the bonus trigger symbol). Determining whether the new symbol is the bonus trigger symbol or a symbol associated with the bonus trigger symbol can include server determining whether new symbol selected from symbol set 400 is associated with a bonus trigger symbol for the bingo ticket (selected at block 618). Referring to the example data shown in Table 6, server device 22 can make the determination of block 636 by determining whether the grid position containing the new symbol or the new symbol itself is selected with a bonus trigger symbol designator (e.g., “B” in Table 6). If server device 22 determines that the new symbol is not the bonus trigger symbol or is not associated with the bonus trigger symbol at block 636, then the set 600 can continue at block 640. If server device 22 determines that the new symbol is the bonus trigger symbol or is associated with the bonus trigger symbol, the set 600 can continue at block 638.

Next, block 638 includes initiating, by server device 22, a bonus feature for the bingo ticket (or bingo strip). Initiating the bonus feature can include executing a bonus game for the player provided with the bingo ticket selected at block 618. Server device 22 can transmit to client device 24 displaying the bingo ticket selected at block 618 data for displaying performance of the bonus game. Displaying performance of the bonus game can occur between two iterations of the bingo match, but is not so limited. The data to display performance of the bonus game could include data indicating an outcome of the game, a video file displaying performance of the bonus game, or some other data. As an example, the bonus game could be a multi-reel slot machine game. Server device 22 can award the player at client device 24 with any award earned as a result of performing the bonus game.

Next, block 640 includes determining, by server device 22, whether the bingo ticket (or bingo strip) contains a predefined pattern of marked grid positions. Preferably, the marked grid positions on the bingo strip include the grid position containing the new symbol. The pre-defined pattern may be a match-ending pattern or an intermediate pattern. If server device 22 determines the bingo ticket does not contain a predefined patter of marked grid positions at block 640, the set 600 can continue at block 644. If server device 22 determines the bingo ticket contains a predefined pattern of marked grid positions, the set 600 can continue at block 642.

Next, block 642 includes awarding, by server device 22, a prize and transmitting an indication the prize has been awarded. If the bingo ticket contains a pre-defined pattern, then, at block 642, server device 22 may award at least some of a prize to the player at client device 24 displaying the bingo ticket and transmit an indication to client device 24 that it has been awarded at least some of the prize. Client device 24 might not be awarded the entire prize because the networked bingo match rules may specify that if two or more client devices 24 qualify to win the same prize on the same iteration of the bingo match, these players or client devices share the prize. The communication device of server device 22 can transmit the indication to the client device displaying the bingo ticket selected at block 618 over a communication network.

Next, block 644 includes determining, by server device 22, whether any remaining bingo tickets (or bingo strips) are to be marked. If at least one more bingo ticket remains to be marked in response to selection of the new symbol, the set 600 can continue at Go To Block 618 in FIG. 6B block, otherwise the set 600 can continue at block 646. Server device 22 can refer to the iteration flag associated with each bingo ticket to determine whether any of the competing bingo strips remain to be marked in response to selection of the scatter symbol.

Next, block 646 includes determining, by server device 22, whether any bingo ticket or bingo strip has a match-ending pattern. If server device 22 determines that none of the competing bingo tickets or bingo strips includes the match-ending pattern, then the set 600 continues at the Go To Block 602 in FIG. 6A block, otherwise, the set 600 continues at block 648.

Next, block 648 includes transmitting, by server device 22 to the client devices 24 competing in the networked bingo match, an indication the networked bingo match has ended.

Any changes to a bingo strip or bingo ticket as a result of performing any function of the set 600 can cause server device 22 to modify the bingo strip or ticket stored in the memory, such as database 33, and to transmit, to the client device 24 displaying the bingo strip or bingo ticket, data to modify the data stored at the client device for displaying the iterations of the networked bingo match.

D. Example Jackpot Games and Progressive Prizes

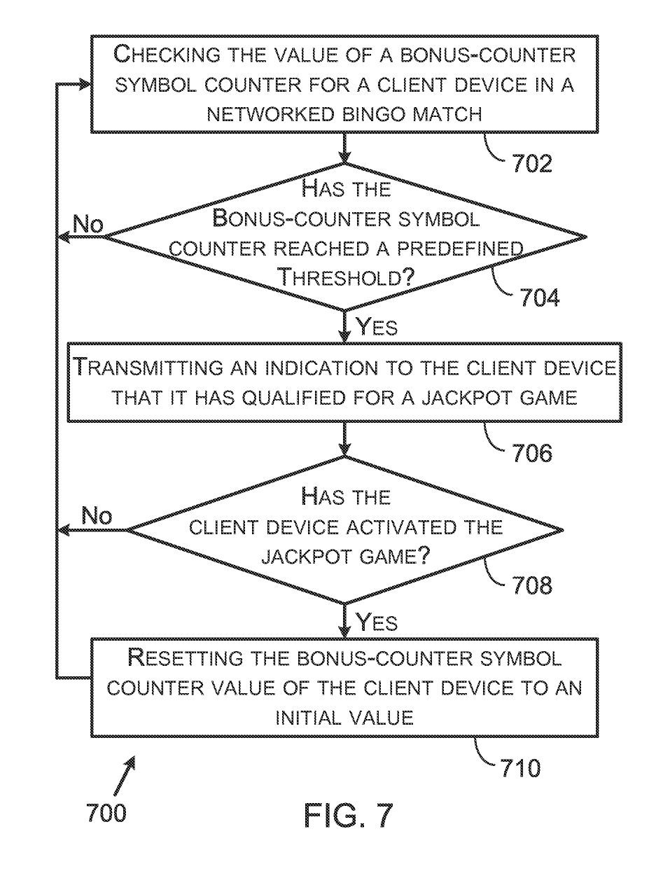

Next, FIG. 7 is a flowchart depicting a set of functions 700 (or more simply “the set 700”) that can be carried out in accordance with one or more example embodiments described herein. The set 700 includes the functions shown in blocks labeled with even numbers 702 through 710, inclusive. A variety of methods can be performed using one or more of the functions shown in set 700 and one or more other functions described herein. The set 700 depicts an example process pertaining to a jackpot game and a networked bingo match. The devices described in this section as performing any part of a function of the set 700 can do so, at least in part, by a processor of that device executing software program instructions.

Block 702 includes checking, by server device 22, the value of a bonus-counter symbol counter for a client device in a networked bingo match. Table 5 shows an example data structure including bonus-counter symbol counter values and a number of accrued jackpot games earned (but not yet played) associated with client device identifiers and player profile identifiers. That data structure can, for example, be stored in database 33. Server device 22 can be configured to check the bonus-counter symbol counter values for each iteration of a networked bingo match. Checking the value of the bonus-counter symbol counter for a client device can include server device 22 checking the value of the bonus-counter symbol counter associated with a player using the client device.

TABLE 5

| Player | Client | Bonus-counter | Jackpot |
|---|---|---|---|
| Profile ID | Device ID | symbol counter | Games |
| 005 | 1A678 | 18 | 0 |
| 218 | 4E773 | 4 | 1 |
| 771 | 3CAA8 | 7 | 0 |
| 689 | 1B004 | 0 | 1 |
| 516 | 4A8B4 | 11 | 0 |
| 111 | 33DC1 | 20 | 0 |

If a client device, such as a client device with ID 4E773, is usable by multiplier players, then the player profile ID associated with that client device can be changed in the data structure to identify the player currently using the client device. Similarly, if a player, such as a player with profile ID 689, uses multiple client devices to play networked bingo, then the client device ID associated with that player profile ID can be changed in the data structure to identify the client device currently being used by that player.

Next, block 704 includes determining, by server device 22, whether the value of the bonus-counter symbol counter (e.g., a bonus-counter symbol counter value in Table 5) has reached a pre-defined threshold. As an example, the predefined threshold can be a number of bonus-counter symbols marked for networked bingo matches for a player since the bonus-counter symbol counter was last set to an initial value. That number of bonus-counter symbols could be 10, 20 or another number of bonus-counter symbols. If server device 22 determines the bonus-counter symbol counter has not reached the predefined threshold for the client device, then set 700 returns to block 702 for another client device competing in the networked bingo match or to check the bonus-counter symbol counter for the client device after or during a next iteration of the bingo match. If server device 22 determines the bonus-counter symbol counter has reached the predefined threshold for the client device, then set 700 can continue at block 706.

Next, block 706 includes transmitting, by server device 22, an indication to client device 24 that it has qualified for a jackpot game. The communication interface of server device 22 can transmit the indication to the client device over a communication network. Client device 24, after receiving the indication, can display the indication to inform a player of the client device that the player is qualified to play the jackpot game. The player can log off a first client device that displays the indication, and log onto a second client device to play the jackpot game.

Next, block 708 includes determining, by server device 22, whether client device 24 has activated the jackpot game. If client device 24 has not activated the jackpot game, server device 22 may return to block 702 and prepare to check the bonus-counter symbol counter of another client device 24 or to check the bonus-counter symbol counter for client device 24 after or during a next iteration of the bingo match. If client device 24 has activated the jackpot game, then the set 700 can continues at block 710 which includes resetting, by server device 22, the value of the bonus-counter symbol counter of the client device to an initial value. After resetting the bonus-counter symbol counter value, the set 700 can continue at block 702 for another client device competing in the networked bingo match or to check the bonus-counter symbol counter for the client device after or during a next iteration of the bingo match.

Any changes to a bingo strip or bingo ticket as a result of performing any function of the set 700 can cause server device 22 to modify the bingo strip or ticket stored in the memory, such as database 33, and to transmit, to the client device 24 displaying the bingo strip or bingo ticket, data to modify the data stored at the client device for displaying the iterations of the networked bingo match.

The jackpot game that a client device 24 may activate may have a single prize, or may have multiple different prizes. These prizes may be static or progressive in nature, and their values and associated data may be stored in database 33.

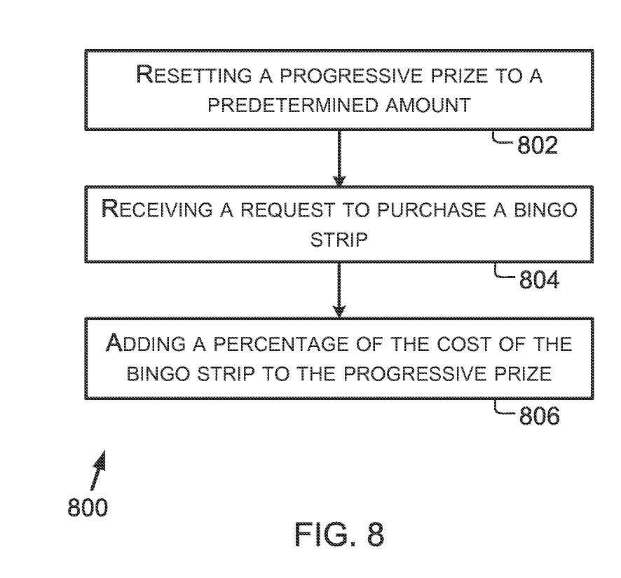

Next, FIG. 8 is a flowchart depicting a set of functions 800 (or more simply “the set 800”) that can be carried out in accordance with one or more example embodiments described herein. The set 800 includes the functions shown in blocks labeled with even numbers 802 through 806, inclusive. A variety of methods can be performed using one or more of the functions shown in set 800 and one or more other functions described herein. The set 800 depicts an example process pertaining to funding a progressive prize. The devices described in this section as performing any part of a function of the set 800 can do so, at least in part, by a processor of that device executing software program instructions.

Block 802 includes resetting a progressive prize to a predetermined amount. The progressive prize may be reset because a prior progressive prize was won by a client device 24, as part of the initialization of one or more networked bingo matches, or for some other purpose.

Next, block 804 includes receiving, by server device 22, a request to purchase a bingo strip. Client device 24 can transmit the purchase request to server device 22 over a communication network, such as communication network 28.

Next, block 806 includes adding, by server device 22, a percentage of the cost (e.g., a purchase price) of the bingo strip to the progressive prize. This way, the progressive prize grows with every player who joins a networked bingo match, until the prize is won. Purchase of a bingo ticket with multiple strips can result in adding a portion of the ticket price or each of the multiple bingo strips to the progressive prize. Adding the cost percentage can be conditioned upon server device 22 receiving confirmation that payment for the purchased bingo strip has successfully occurred.

Server device 22 can transmit an indicator of the progressive prize value to a client device. Transmission of the progressive prize value indicator can occur automatically without request from a client device, such as a client device owned or operated by a casino. Alternatively, transmission of the progressive prize value indicator can occur in response to a request, such as a request to logon to server device 22 or a portal 23a, 23b to play a networked bingo game. A client device 24 can display a progressive prize value indicator as an enticement to encourage players to play or to continue playing networked bingo matches.

Any changes to a bingo strip or bingo ticket as a result of performing any function of the set 800 can cause server device 22 to modify the bingo strip or ticket stored in the memory, such as database 33, and to transmit, to the client device 24 displaying the bingo strip or bingo ticket, data to modify the data stored at the client device for displaying the iterations of the networked bingo match.

E. Example Bonus Features

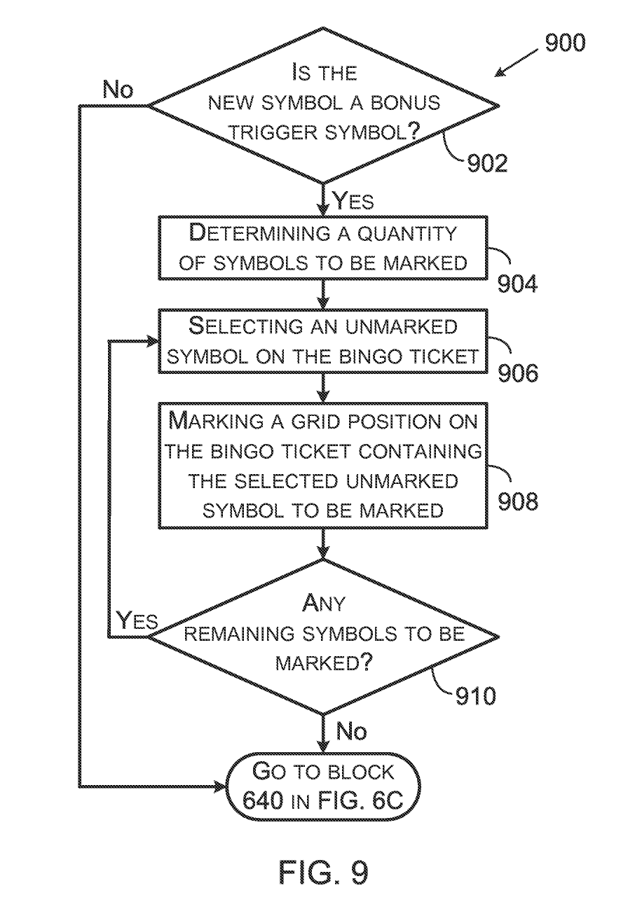

Next, FIG. 9 is a flowchart depicting a set of functions 900 (or more simply “the set 900”) that can be carried out in accordance with one or more example embodiments described herein. The set 900 includes the functions shown in blocks labeled with even numbers 902 through 910, inclusive, and in a “Go to” block. A variety of methods can be performed using one or more of the functions shown in set 900 and one or more other functions described herein. The set 900 depicts an example process pertaining to a bonus feature as part of a networked bingo match. The devices described in this section as performing any part of a function of the set 900 can do so, at least in part, by a processor of that device executing software program instructions.

Block 902 includes determining, by server device 22, whether the new symbol is a bonus trigger symbol. Determining that the new symbol is the bonus trigger symbol can include determining that the symbol selected from symbol set 400 is associated with the bonus trigger symbol. To make that determination, server device 22 can select the new symbol using a random selection process and compare the selected new symbol to the bingo ticket or bingo strip stored in a memory, such as database 33, for each player competing in the networked bingo match.

As an example, if the selected new symbol is “15,” server device 22 can check a stored bingo strip, such as bingo ticket 302 shown in FIG. 3 and Table 4, to determine that the symbol “15” on bingo ticket 302 is not associated with the bonus trigger symbol, and therefore the new symbol is not the bonus trigger symbol.

As another example, if the selected new symbol is “57,” server device 22 can check a bingo strip, such as bingo ticket 302, to determine that the symbol “57” is associated with the bonus trigger symbol, and therefore the new symbol can be considered the bonus trigger symbol.

If server device 22 determines that the new symbol is not the bonus trigger symbol, is not associated with the bonus trigger symbol or is otherwise not considered the bonus trigger symbol, then the set 900 continues at the Go To Block 644 in FIG. 6C block. If server device 22 determines the new symbol is the bonus trigger symbol, then the set 900 continues at block 904.

Next, block 904 includes determining, by server device 22, a quantity of symbols to be marked. Server device 22 can use a random selection process to determine the quantity of symbols to be marked as an award for the bonus trigger symbol being selected. As an example, server device 22 can randomly select a number between 1 and T, inclusive, where T equals for example, 3, 4, or another number. The quantity of symbols to be marked can equal the randomly selected number, such as, 1, 2, 3, or 4. After or while determining the quantity of symbols to be marked, server device 22 can prepare to mark the quantity of symbols on the bingo strip. That preparation can include, but is not limited, to setting a bonus-trigger quantity symbol counter to a value that equals the quantity of symbols to be marked.

Next, block 906 includes selecting, by server device 22, an unmarked symbol on the bingo ticket. Server device 22 can refer to the bingo ticket stored in memory, such as database 33, to determine which symbols on the bingo ticket are unmarked or which grid positions on the bingo ticket are unmarked or include a symbol that is unmarked. Selecting an unmarked symbol can be conditioned on the unmarked symbol not being associated with an extra symbol, such as a bonus-counter symbol, a multiplier symbol, or a bonus trigger symbol. Selecting an unmarked symbol can be conditioned on the unmarked symbol not being a free space symbol. Alternatively, however, an unmarked symbol selected for block 906 could be associated with an extra symbol or could be a free space symbol if so desired for a variation of the networked bingo match. If server device 22 is using a bonus-trigger quantity symbol counter, server device 22 can adjust that counter by a value of one after selecting an unmarked symbol at block 906.

Next, block 908 includes marking, by server device 22, a grid position on the bingo ticket (or bingo strip) containing the selected unmarked symbol to be marked. Server device 22 can mark the bingo ticket or bingo strip by modifying the bingo ticket or bingo strip stored in the memory, such as database 33, to indicate the symbol is marked. As an example, modifying a bingo strip can include modifying bingo ticket 302 shown in Table 4. An example of the data representing the modified bingo strip is shown in Table 6.

TABLE 6

| | | | | | | | | |
|---|---|---|---|---|---|---|---|---|
| FS/Y | 45/Z | FS/Y | 6/Z | 77/Z | FS/Y | 38/Z | 4/Z | FS/Y |
| FS/Y | 18/X/Z | FS/Y | FS/Y | 15/Z | 82/Z | 55/Y | FS/Y | 51/B/Z |
| 1/Y | FS/Y | FS/Y | 69/Z | FS/Y | 44/M/Z | 16/Y | 88/Z | FS/Y |

As an example, the data representing the bingo strip can be stored in a configuration of (symbol identifier, grid position, extra symbol (if any), and marked status (Y for marked and Z for unmarked)). In that case, if symbols 1, 16, and 55 and free spaces are selected to be marked or are already marked for bingo ticket 302 and the remaining symbols are unmarked, the stored data can be configured as: (FS, 1, Y), (45, 2, Z), (FS, 3, Y), (6, 4, Z), (77, 5, Z), (FS, 6, Y), (38, 7, Z), (4, 8, Z), (FS, 9, Y), (FS, 10, Y), (18, 11, X, Z), (FS, 12, Y), (FS, 13, Y), (15, 14, Z), (82, 15, Z), (55, 16, Y), (FS, 17, Y), (57, 18, Z), (1, 19, Y), (FS, 20, Y), (FS, 21, Y), (69, 22, Z), (FS, 23, Y), (44, 24, M, Z), (16, 25, Y), (88, 26, Z), (FS, 27, Y). Other examples configurations for storing data representing the selected symbol and an associated grid position and extra symbols are also possible.

Next, block 910 includes determining, by server device 22, whether any remaining symbols are to be marked. Server device 22 can refer to the bonus-trigger quantity symbol counter to determine whether any remaining symbols are to be marked. If at least one unmarked symbol remains to be marked in response to the new symbol being or associated with the bonus trigger symbol, the set 900 continues at block 906. If no additional unmarked symbols remain to be marked in response to the new symbol being or associated with the bonus trigger symbol, the set 900 continues at the Go To Block 644 in FIG. 6C block.

Any changes to a bingo strip or bingo ticket as a result of performing any function of the set 900 can cause server device 22 to modify the bingo strip or ticket stored in the memory, such as database 33, and to transmit, to the client device 24 displaying the bingo strip or bingo ticket, data to modify the data stored at the client device for displaying the iterations of the networked bingo match.

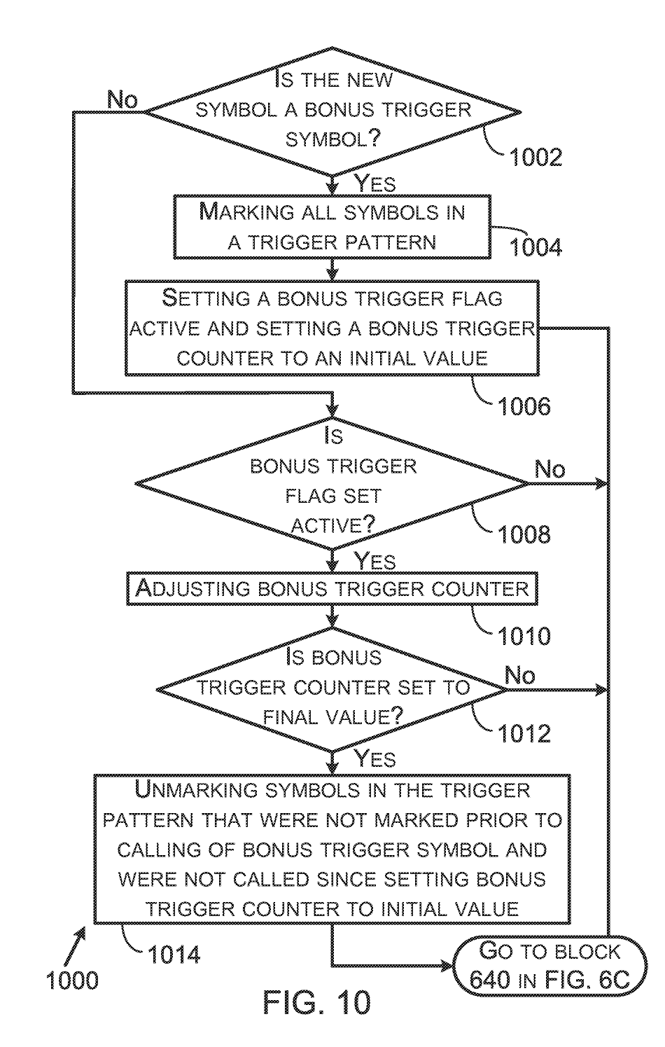

Next, FIG. 10 is a flowchart depicting a set of functions 1000 (or more simply “the set 1000”) that can be carried out in accordance with one or more example embodiments described herein. The set 1000 includes the functions shown in blocks labeled with even numbers 1002 through 1014, inclusive, and in a “Go to” block. A variety of methods can be performed using one or more of the functions shown in set 1000 and one or more other functions described herein. The set 1000 depicts an example process pertaining to a bonus feature as part of a networked bingo match. The devices described in this section as performing any part of a function of the set 1000 can do so, at least in part, by a processor of that device executing software program instructions.

Block 1002 includes determining, by server device 22, whether the new symbol is a bonus trigger symbol. The new symbol is a symbol selected from symbol set 400 for an iteration of a networked bingo match. The new symbol can be associated with the bonus trigger symbol. Determining the new symbol is the bonus trigger symbol can include determining that the symbol selected from the set of symbols 400 is associated with the bonus trigger symbol. If server device 22 determines that the new symbol is a bonus trigger symbol or is associated with the bonus trigger symbol, the set 1000 proceeds to block 1004, otherwise, if server device 22 determines that the new symbol is not the bonus trigger symbol or is not associated with the bonus trigger symbol, the set 1000 proceeds to block 1008.

Block 1004 includes marking, by server device 22, all of the symbols in a trigger pattern. The trigger pattern can be predefined or selected by server device 22 in response to determining the new symbol is a bonus trigger symbol or a symbol associated with the bonus trigger symbol. As an example, the trigger pattern can be a column of a bingo ticket or of a bingo strip (e.g. a column in which the bonus trigger symbol occurs or is positioned). Referring to FIG. 4, if the new symbol is within grid position 86 along with the bonus trigger symbol, then the trigger pattern can be column 5 of bingo ticket 300. As another example, the trigger pattern can be a row of a bingo ticket or bingo strip (e.g., a row in which the bonus trigger symbol occurs or is positioned). Referring to FIG. 4, if the new symbol is within grid position 86 along with the bonus trigger symbol, then the trigger pattern can be row 10 of bingo strip 308. Other examples of the trigger patterns, especially for bingo strips or tickets having non-rectangular shapes, are also possible.

Next, block 1006 includes setting, by server device 22, a bonus trigger flag active and setting a bonus trigger counter value to an initial value. As an example, the initial value of the bonus trigger counter can be 5. The bonus trigger counter can have a final value, such as 0, such that adjusting the bonus trigger counter can occur by decrementing the bonus trigger counter. A memory, such as database 33, can store a respective bonus trigger flag and a respective bonus trigger counter for each player of the networked bingo match, as well as players that have previously played or at least registered to play a networked bingo match. After the bonus trigger flag is set to active and the bonus trigger counter is set to the initial value at block 1006, the set 1000 continues at the Go To Block 640 in FIG. 6C block.

Block 1008 includes determining, by server device 22, whether the bonus trigger flag is set active. If server device 22 determines that the bonus trigger flag is not set to active (or set to non-active), the set 1000 continues at the Go To Block 640 in FIG. 6C block, otherwise, if server device 22 determines that the bonus trigger flag is set to active, the set 1000 continues at block 1010.

Next, block 1010 includes adjusting, by server device 22, the bonus trigger counter. Adjusting the bonus trigger counter can include incrementing the counter by a value of 1 or decrementing the counter by a value of 1. The memory, such as database 33, stores the adjusted bonus trigger counter. After adjusting the bonus trigger counter to its final value, server device 22 can set the bonus trigger flag to inactive.

Next, block 1012 includes determining, by server device 22, whether the bonus trigger counter is set to a final value. If server device 22 determines that the bonus trigger counter is not set to the final value, the set 1000 continues at the Go To Block 640 in FIG. 6C block, otherwise, if server device 22 determines that the bonus trigger counter is set to the final value or is set to a value other than the final value, the set 1000 continues at block 1014.

Next, block 1014 includes unmarking symbols in the trigger pattern that were not marked prior to calling of the bonus trigger symbol (e.g., selecting the bonus trigger symbol or a symbol associated with the bonus trigger symbol) and were not called since setting the bonus trigger counter to the initial value. In accordance with the example in which the initial value of the bonus trigger counter is 5, if the marked symbols in the trigger pattern were not called within the last five iterations of the networked bingo game, those symbols are unmarked as part of performing the function of block 1014. After unmarking the symbols at block 1014, the set 1000 continues at the Go To Block 640 in FIG. 6C block.

Any changes to a bingo strip or bingo ticket as a result of performing any function of the set 1000 can cause server device 22 to modify the bingo strip or ticket stored in the memory, such as database 33, and to transmit, to the client device 24 displaying the bingo strip or bingo ticket, data to modify the data stored at the client device for displaying the iterations of the networked bingo match.

### IX. Example Networked Bingo Matches

The following example embodiments describe two variations of networked bingo that may be enabled according to the methods, devices, and systems described herein. In order to participate in an iteration of a bingo match, a client device 24 is provided with one or more bingo tickets or bingo strips. Client device may provide a payment prior to receiving the bingo tickets or strips. The payments received from the bingo tickets or strips purchased by client devices 24 are accumulated and a portion thereof, for example 20%, may be paid over to an operator of the bingo portal 23a, 23b. The remainder of the accumulated payment may form a prize that that can be won by a client device 24 competing in a bingo match.

A. 75-Symbol Networked Bingo Match

In this embodiment, the value of N for symbol sets 402 and 416 is 75 such that symbol sets 402 and 416 include 75 symbols numbered from 1 to 75, inclusive. Each bingo strip has 25 grid positions arranged in 5 rows and 5 columns. Each grid position on a bingo strip is associated, randomly, with a number between 1 and 75 corresponding to one of the 75 symbols. A bingo ticket consists of 3 bingo strips. Every symbol from 1 to 75 may appear only once in a grid position on a set. Moreover, one or more of the grid positions of one or more bingo strips on the bingo ticket can include a free space symbol instead of a symbol from symbol set 416.

A 75-symbol bingo match can commence with server device 22 generating a random number between 1 and 75 and transmitting this random number to a client device 24. If the generated random number appears on any of the bingo strips or tickets provided to client device 24, the corresponding grid positions on the bingo strips or tickets are “marked off”, for example by greying out, highlighting or marking the grid positions with an “X.” Server device 22 then checks whether an intermediate pattern or a match-ending pattern has occurred on any bingo ticket of any client device 24. If neither of the intermediate-pattern or the match-ending pattern occurs, server device 22 generates another random number in the same range and without replacement, and the above process repeats.

The following intermediate patterns and match-ending patterns are defined, each of which has an associated prize: intermediate pattern (or more simply “IP1”), in which a client device 24 wins 12% of the prize by being the first client device 24 to mark one complete horizontal line of grid positions on a bingo ticket, intermediate pattern (or more simply “IP2”), in which a client device 24 wins 18% of the prize by being the first client device 24 to mark two complete horizontal lines of grid positions on a bingo ticket, and a match-ending pattern, in which a client device 24 wins 70% of the prize by being the first client device 24 to successfully mark off all the grid positions on a bingo ticket in a bingo set.

If server device 22 detects the occurrence of an intermediate pattern, a prize associated with that intermediate pattern is credited to client device 24 on whose bingo ticket the intermediate pattern occurred. The networked bingo match then continues. When server device 22 detects the occurrence of a match-ending pattern, the prize associated with the match-ending pattern is credited to client device 24 on whose bingo ticket the match-ending pattern occurred, and the networked bingo match terminates. A new networked bingo match may commence, and client devices 24 participating in the new networked bingo match may be each provided with at least one new bingo ticket. If two or more client devices 24 achieve an intermediate pattern or a match-ending pattern on the same iteration of the networked bingo match, the associated prize may be shared equally among these client devices 24.

This embodiment of networked bingo offers client devices 24 a jackpot prize as described herein. This prize can be a fixed prize that is paid by the operator of the bingo portal 23a, 23b, or, alternatively, a progressive prize that is funded in a manner that is described elsewhere herein.

B. 90-Symbol Networked Bingo Match

In this embodiment, the value of N for symbol sets 402 and 416 is 90 such that symbol sets 402 and 416 include 90 symbols numbered from 1 to 90, inclusive. Each bingo strip consists of 3 rows and 9 columns, such as strips 302 to 312. Each row has 5 numbered squares and 4 “free space” symbols that are not numbered. It will thus be appreciated that each bingo ticket will contain 15 grid positions, each of which is associated, randomly, with a number between 1 and 90 corresponding to one of the 90 symbols available in the bingo game. A set of 6 such bingo tickets is called a strip and, in such a strip, every number from 1 to 90 appears in a grid position only once. Therefore, for every ball drawn by server device 22, only 1 grid position will be marked across the 6 bingo tickets.

This embodiment of the bingo game has the same intermediate patterns and match-ending patterns as that of the 75 symbol embodiment described above. Furthermore, the jackpot prize is won, as above.

C. Transmitting Bingo Match Sequences

The description of the 75-symbol networked bingo match describes selection of a symbol and transmission of the symbol to client device 24. Server device 22 can be configured to select a symbol and transmit the selected symbol (or an indication thereof) to the client devices 24 competing in the networked bingo match for each iteration of the bingo match prior to commencing a next iteration of the bingo match. Alternatively, server device 22 can be configured to select multiple symbols for multiple iterations of the networked bingo match before transmitting a sequence of the multiple selected symbols. In one case, server device 22 is configured to select all symbols for the networked bingo match until a match-ending pattern is achieved. In that case, server device 22 can send a sequence of symbol to the client devices competing in the networked bingo match. Server device 22 can send with the sequence of symbols, a delay or interval time the client devices are to use between displaying each next symbol of the sequence of symbols. Alternatively, the clients devices can be programmed to display the sequence of symbols using the delay or interval time such that server device 22 does not have to provide the client devices with the delay or interval time.

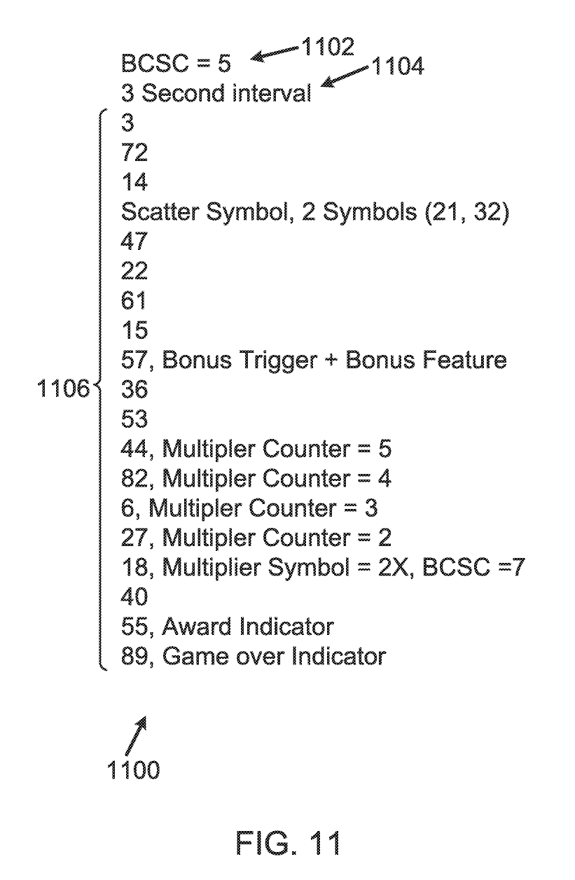

Next, FIG. 11 illustrates an example bingo match sequence 1100. The sequence can be stored generated by server device 22, stored in a memory, such as database 33, transmitted to client device 24 over a communication network, stored in a memory at client device 24, and used for displaying performance of a networked bingo match on display 25. Bingo match sequence 1100 includes a bonus-counter symbol counter (BCSC) value (e.g. 5) for displaying the BCSC value on display 25 to provide an indication of achieving a jackpot game. Displaying the BCSC value can be carried out by displaying a number of medals or medallions on display 25 or in another manner. Bingo match sequence 1100 includes a bingo match iteration value 1104, such as 3 seconds. Bingo match iteration value 1104 can be used to set a pace for displaying each called symbol in the bingo match. Different values of bingo match iteration value 1104 could be used. Furthermore, client device 24 can store a bingo match iteration value such that bingo match sequence does not need bingo match iteration value 1104.

Bingo match sequence 1100 includes a sequence of called symbols 1106. The first called symbol in called symbols 1106 is “3” and the last called symbol is “89,” which can be accompanied or associated with a game over indicator. In between the first and last called symbols are 17 symbols selected from symbol set 400 in which N equals 90. One of the called symbols is the scatter symbol 406, which can be accompanied by an identification of two unmarked symbols “21” and “32” to mark on the bingo strip displayed by client device that receives bingo match sequence 1100.

Called symbols 1106 includes “57” which is a symbol associated with the bonus trigger symbol on bingo ticket 302, as shown in Table 4. Bingo match sequence 1100 can include a bonus trigger symbol indicator and a bonus feature indicator. The bonus feature indicator can include data for playing the bonus feature, such as the multi-reel slots game.

Called symbols 1106 includes “44” which is a symbol associated with the multiplier symbol on bingo ticket 302, as shown in Table 4. Bingo match sequence 1100 can include the initial value of a multiplier counter (e.g., 5) with called symbol “44.” Values of the multiplier counter can accompany subsequent called symbols until the multiplier counter reaches its final value or a bonus-counter symbol or a symbol associated with the bonus-counter symbol, such as symbol “18” is called. Accompanying called symbol “18” is a value of the multiplier symbol “2×” and an adjusted value of the BCSC.

Considering the symbols of called sequence 1106 are being marked on bingo ticket 302, when symbol “55” is called, row 2 of bingo ticket 302 is completely marked and bingo match sequence 1100 provides an award indicator along with called symbol “55.” In the event that the player playing bingo ticket 302 won the bingo match, another award indicator could have accompanied the game over indicator along with the last symbol called.

Server device 22 can call all symbols for bingo match sequence 1100 before transmitting bingo match sequence 1100 to a client device. The use of the extra symbols and maintaining different flags and counters for each player provided with a bingo ticket for the bingo match can result in server device 22 providing each client device a different bingo match sequence. At a minimum, the different bingo match sequence can result because of the globally-designated scatter symbol and random selection of unmarked symbols on the bingo ticket, especially for bingo games in which all selectable symbols from symbol set 402 do not appear on all competing bingo tickets.

Server device 22 can transmit bingo match sequence 1100 using any of a variety of protocols, such as, but not limited to, transmission control protocol/internet protocol (TCP/IP) or user data protocol (UDP). Client device 24 can receive bingo match sequence 1100 and cause display 25 to display called symbols 1106 according to the sequence, and to display the various indicators and counters provided in bingo match sequence 1100 on a bingo ticket provided to client device 24. The other counters and the flags described herein can be provided to client device 24 within bingo match sequence for displaying by display 25 to show a status of the bingo match.

### X. Additional Example Embodiments

The following examples set out further or alternative aspects of the disclosure. Any use of a reference character shown in a figure and any reference to a figure number within these additional example embodiments are for ease of reference only and are not limiting on the scope of the disclosures in accordance with these various aspects.

### Example 1

A method comprising: generating, by a computer-readable processor, computer-readable bingo tickets; providing, over a communication network, multiple generated bingo tickets for use in a networked bingo match, wherein the multiple generated bingo tickets include a first bingo ticket; selecting, by the processor and from among a set of selectable symbols, a set of symbols for the networked bingo match; and determining, by the processor from among the multiple bingo tickets provided for use in the networked bingo match and based on the selected set of symbols, a winning bingo ticket that wins the networked bingo match.

### Example 2

The method of example 1, wherein the set of symbols for the networked bingo match includes multiple distinct symbols, the method further comprising: storing, by a computer-readable medium, the first bingo ticket and sequence data indicating a sequence of the multiple distinct symbols from a first selected symbol to a last selected symbol, wherein providing the multiple generated bingo tickets includes transmitting, by the processor over a communication network, the first bingo ticket and the sequence data to a device including a first display for displaying the first bingo ticket and the set of symbols being marked on the first bingo ticket according to the sequence data.

### Example 3

The method of example 2, wherein providing the multiple generated bingo tickets includes transmitting, by the processor over a communication network, at least a second bingo ticket of the multiple generated bingo tickets and the sequence data to a second device including a display for displaying the second bingo ticket and the set of symbols being marked on the second bingo ticket according to the sequence data.

### Example 4

The method any of any of examples 1 to 3, wherein selecting the set of symbols includes selecting multiple distinct symbols, and wherein the set of selectable symbols includes a scatter symbol, the method further comprising: determining, by the processor, a selected symbol of the set of symbols for the networked bingo match is the scatter symbol; determining, by the processor for each bingo ticket provided for the networked bingo match, a respective quantity of symbols to be marked on each bingo ticket provided for the networked bingo match in response to the scatter symbol being selected; selecting, by the processor for each bingo ticket provided for the networked bingo match, a quantity of unmarked symbols on the bingo ticket that equals the respective quantity of symbols selected for the bingo ticket; and marking, by the processor for each bingo ticket provided for the networked bingo match, each grid position on the bingo ticket that includes an unmarked symbol of the quantity of unmarked symbols selected for the bingo ticket.

### Example 5

The method of example 4, wherein determining each respective quantity of symbols includes selecting, by the processor, a number using a random process.

### Example 6

The method of example 4, wherein selecting each additional unmarked symbol of the quantity of unmarked symbols for the bingo tickets provided for the networked bingo match is conditioned on determining, by the processor, that marking an unmarked symbol on one or more of the bingo tickets provided for the networked bingo match does not result in the winning bingo ticket winning the networked bingo match.

### Example 7

The method of any of examples 4 to 6, wherein the scatter symbol is selectable for determining the bingo ticket that wins the networked bingo match but is not selectable for generating any of the computer-readable bingo tickets.

### Example 8

The method of any of examples 4 to 6, wherein the scatter symbol is selectable for determining the bingo ticket that wins the networked bingo match and is selectable for generating any of the computer-readable bingo tickets.

### Example 9

The method of any of examples 1 to 8, further comprising: selecting, by the processor, the first bingo ticket to include a bonus-counter symbol; and selecting, by the processor, a first symbol on the first bingo ticket within a first grid position for including the bonus-counter symbol on the first bingo ticket, wherein generating the first bingo ticket includes generating the first bingo ticket to include the first symbol and the bonus-counter symbol within the first grid position.

### Example 10

The method of example 9, wherein selecting the set of symbols for the networked bingo match includes selecting the first symbol from among the set of selectable symbols, the method further comprising: storing, by a computer-readable medium, for each bingo ticket provided for the networked bingo match that includes the first symbol, data representing a grid position including the first symbol for the bingo ticket is a marked grid position for a remainder of the networked bingo match; storing, by the computer-readable medium, a respective bonus-counter symbol counter for each player provided with at least one bingo ticket for the networked bingo match; and after selecting the first symbol, adjusting, by the processor, the respective bonus-counter symbol counter for each bingo ticket provided for the networked bingo match that includes the first symbol and the bonus-counter symbol in a single grid position within the bingo ticket.

### Example 11

The method of example 10, wherein adjusting the respective bonus-counter symbol counter for each bingo ticket includes incrementing or decrementing the respective bonus-counter symbol counter.

### Example 12

The method of any of examples 10 to 11, further comprising: selecting, by the processor, the first bingo ticket including the bonus-counter symbol to include a multiplier symbol; and selecting, by the processor, a second symbol on the first bingo ticket within a second grid position for including the multiplier symbol on the first bingo ticket, wherein generating the first bingo ticket includes generating the first bingo ticket to include the second symbol and the multiplier symbol within the second grid position.

### Example 13

The method of example 12, wherein selecting the set of symbols for the networked bingo match includes selecting the second symbol from among the set of selectable symbols, the method further comprising: storing, by a computer-readable medium, for each bingo ticket provided for the networked bingo match that includes the second symbol, data representing a grid position including the second symbol for the bingo ticket is a marked grid position for a remainder of the networked bingo match; storing, by the computer-readable medium, a respective post-multiplier-symbol-selection counter for each bingo ticket for the networked bingo game including the second symbol and a multiplier symbol in a single grid position; and after selecting the second symbol that is within second grid position including the multiplier symbol, setting by the processor, the post-multiplier-symbol-selection counter for the first bingo ticket, to an initial value, wherein adjusting the bonus-counter symbol counter for the first bingo ticket includes adjusting the bonus-counter symbol counter by a value of one times a multiplier value associated with the multiplier symbol if the post-multiplier-symbol-selection counter has not been adjusted to a final value, otherwise, adjusting the bonus-counter symbol counter for the bingo ticket includes adjusting the bonus-counter symbol counter by the value of one.

### Example 14

The method of example 13, wherein adjusting bonus-counter symbol counter by the value of one times the multiplier value associated with the multiplier symbol is conditioned on selecting the first symbol after selecting the second symbol.

### Example 15

The method of any one of examples 13 to 14, further comprising: after selecting the second symbol that is within second grid position including the multiplier symbol, and prior to selecting the first symbol that is within the grid position including the bonus-counter symbol, and after selecting at least one other symbol from among the set of selectable symbols for the networked bingo match, adjusting, by the processor, the post-multiplier-symbol-selection counter by a value of one for each of the at least one other symbol selected until the post-multiplier-symbol-section counter equals the final value.

### Example 16

The method of example 13, wherein adjusting bonus-counter symbol counter by the value of one times the multiplier value associated with the multiplier symbol is conditioned on selecting the first symbol before selecting the second symbol.

### Example 17

The method of example any of examples 10 to 16, further comprising: determining, by the processor, the bonus-counter symbol counter for the first bingo ticket is adjusted to a predefined threshold value; transmitting, by the processor to a device displaying the first bingo ticket, an indicator that indicates a bingo player using the device displaying the first bingo ticket is qualified to play a jackpot game; receiving, by the processor, a request to activate the jackpot game; and setting, by the processor, the bonus-counter symbol counter to an initial bonus-counter symbol counter value.

### Example 18

The method of example any of examples 12 to 17, wherein the multiplier symbol is associated with a multiplier value, and wherein the multiplier value is a positive integer within a range of 2 to 5, inclusive.

### Example 19

The method of example 18, wherein the multiplier value is 2.

### Example 20

The method of any of examples 1 to 19, wherein the processor randomly selects bingo tickets to include a bonus-counter symbol, and wherein at least one of the multiple generated bingo tickets for use in the networked bingo match does not include a bonus-counter symbol and at least one of the multiple generated bingo tickets for use in the networked bingo match includes a bonus-counter symbol.

### Example 21

The method of any of examples 9 to 20, wherein the bonus-counter symbol comprises a medallion symbol.

### Example 22

The method of any of examples 1 to 21, further comprising: selecting, by the processor, the first bingo ticket to include a bonus trigger symbol, and selecting, by the processor, a third symbol on the first bingo ticket within a third grid position for including the bonus trigger symbol, wherein generating the first bingo ticket includes generating the first bingo ticket to include the third symbol and the bonus trigger symbol within the third grid position.

### Example 23

The method of example 22, wherein selecting the set of symbols from among the set of selectable symbols for the networked bingo match includes selecting the third symbol, the method further comprising: storing, by a computer-readable medium, for each bingo ticket provided for the networked bingo match that includes the third symbol, data representing a grid position including the third symbol for the bingo ticket is a marked grid position for a remainder of the networked bingo match; storing, by the data storage device, a bonus-trigger-symbol counter for the first bingo ticket; setting, by the processor, the. bonus-trigger-symbol counter for the first bingo ticket to an initial value; and in response to selecting the third symbol during the networked bingo match, selecting at least one additional symbol, other than the third symbol, on the first bingo ticket and marking each grid position on the first bingo ticket including a symbol of the at least one additional symbol.

### Example 24

The method of example 23, wherein marking each grid position on the first bingo ticket including a symbol of the at least one additional symbol includes marking at least one grid position in a column on the first bingo ticket such that all grid positions in the column are marked.

### Example 25

The method of example 24, wherein the column includes the third symbol.

### Example 26

The method of example 23, wherein marking each grid position on the first bingo ticket including a symbol of the at least one additional symbol includes marking at least one grid position in a row on the first bingo ticket such that all grid positions in the row are marked.

### Example 27

The method of example 26, wherein the row includes the third symbol.

### Example 28

The method of example 23, wherein marking each grid position on the first bingo ticket including a symbol of the at least one additional symbol includes marking a quantity of unmarked grid positions on the first bingo ticket, and wherein the processor selects the unmarked grid positions from among any remaining unmarked grid positions on the first bingo ticket randomly.

### Example 29

The method of any of examples 23 to 28, further comprising: adjusting, by the processor, the bonus-trigger-symbol counter for the first bingo ticket in response to selecting, by the processor, a symbol from the set of selectable symbols while the bonus-trigger-symbol counter for the first bingo ticket is set to the initial value or to a value between the initial value and an end value of the bonus-trigger-symbol counter for the first bingo ticket; storing, by the data storage device, data representing each grid position on the first bingo ticket including a symbol of the at least one additional symbol is a marked grid position for the networked bingo match; and modifying, by the processor in response to the processor adjusting the bonus-trigger-symbol counter for the first bingo ticket to the end value during the first networked bingo match, the data representing each grid position on the first bingo ticket including a symbol of the at least one additional symbol is a marked grid position for the networked bingo match to indicate the symbol of the at least one additional symbol is an unmarked grid position for the networked bingo match if the symbol of the at least one addition symbol was not selected during a time when the bonus-trigger-symbol counter for the first bingo ticket was the initial value or a value between the initial value and the end value during the first networked bingo match.

### Example 30

The method of any of examples 23 to 28, wherein adjusting the bonus-trigger-symbol counter for the first bingo ticket includes incrementing or decrementing the bonus-trigger-symbol counter for the first bingo ticket.

### Example 31

The method of an of examples 22 to 30, wherein each of the other bingo tickets of the multiple generated bingo tickets includes the bonus trigger symbol and a symbol selectable from the set of selectable symbols within a single grid position of the other bingo ticket, the method further comprising: storing, by the data storage device, a respective bonus-trigger-symbol counter for the each of the other bingo tickets of the multiple generated bingo tickets; and in response to selecting the symbol selectable from the set of selectable symbols within the single grid position of the other bingo ticket during the networked bingo match, selecting at least one additional symbol, on the other bingo ticket and marking each grid position on the other bingo ticket including a symbol of the at least one additional symbol.

### Example 32

The method of example 31, further comprising: adjusting, by the processor, the bonus-trigger-symbol counter for the other bingo ticket in response to selecting, by the processor, a symbol from the set of selectable symbols while the bonus-trigger-symbol counter for the other bingo ticket is set to the initial value or to a value between the initial value and an end value of the bonus-trigger-symbol counter for the other bingo ticket; storing, by the data storage device, data representing each grid position on the other bingo ticket including a symbol of the at least one additional symbol on the other bingo ticket is a marked grid position for the networked bingo match; and modifying, by the processor in response to the processor adjusting the bonus-trigger-symbol counter for the other bingo ticket to the end value during the first networked bingo match, the data representing each grid position on the other bingo ticket including a symbol of the at least one additional symbol is a marked grid position for the networked bingo match to indicate the symbol of the at least one additional symbol is an unmarked grid position for the networked bingo match if the symbol of the at least one addition symbol was not selected during a time when the bonus-trigger-symbol counter for the other bingo ticket was the initial value or a value between the initial value and the end value during the first networked bingo match.

### Example 33

The method of any of examples 1 to 32, wherein each generated bingo ticket includes a set of multiple grid positions; the method further comprising: selecting, by the processor for each grid position of multiple grid positions on each generated bingo ticket and from among the set of selectable symbols, a symbol to be positioned within the grid position; and storing, by a computer-readable medium, data representing each generated bingo ticket, wherein the data representing each generated bingo ticket includes data indicating a symbol selected to be positioned within a grid position of the multiple grid positions on the bingo ticket.

### Example 34

The method of example 33, further comprising: selecting, by the processor, at least one grid position on each generated bingo ticket to be a free space, wherein the data representing each generated bingo ticket includes data indicating the free space to be positioned within a grid position on the bingo ticket.

### Example 35

The method of any of examples 1 to 34, wherein the set of selectable symbols includes each integer within the range of 1 to 75, inclusive.

### Example 36

The method of example 35, wherein the set of selectable symbols further includes a scatter symbol.

### Example 37

The method of any of examples 35 to 36, wherein generating each bingo ticket of the multiple generated bingo tickets includes generating a bingo ticket with three grids, each grid including a five by five matrix of grid positions.

### Example 38

The method of any of examples 1 to 37, wherein the set of selectable symbols includes each integer within the range of 1 to 90, inclusive.

### Example 39

The method example 38, wherein the set of selectable symbols further includes a scatter symbol.

### Example 40

The method of any of examples 38 to 39, wherein generating each bingo ticket of the multiple generated bingo tickets includes generating a bingo ticket with six grids, each grid including a three by nine matrix of grid positions.

### Example 41

The method of any of examples 1 to 40, wherein selecting each symbol of the set of symbols for the networked bingo match includes generating, by the processor, a random number associated with the symbol.

### Example 42

The method of any of examples 1 to 41, further comprising: receiving, by the processor, an indication of a payment for generating the first bingo ticket; validating, by the processor, the payment; updating, by the processor, a profile of a client device; transmitting, by the processor, an indication of success to the client device; and transmitting, by the processor, an indication of a user-name and a password to the client device.

### Example 43

The method of any of examples 1 to 42, wherein marking any grid position on a bingo ticket including a symbol from the set of selectable symbols within the any grid position includes marking the symbol within the any grid position.

### Example 44

A machine (22) comprising: a computer-readable processor; a computer-readable data storage medium storing computer-readable program instructions, that when executed by the processor, cause a set of functions to be performed, the set of functions comprising: generating, by a computer-readable processor, computer-readable bingo tickets; providing, over a communication network, multiple generated bingo tickets for use in a networked bingo match, wherein the multiple generated bingo tickets include a first bingo ticket; selecting, by the processor and from among a set of selectable symbols, a set of symbols for the networked bingo match; and determining, by the processor from among the multiple bingo tickets provided for use in the networked bingo match and based on the selected set of symbols, a winning bingo ticket that wins the networked bingo match.

### Example 45

The machine (22) of example 44, wherein the set of symbols for the networked bingo match includes multiple distinct symbols, wherein the set of functions further comprises: storing, by a computer-readable medium, the first bingo ticket and sequence data indicating a sequence of the multiple distinct symbols in a selection order from a first selected symbol to a last selected symbol, wherein providing the multiple generated bingo tickets includes transmitting, by the processor over a communication network, the first bingo ticket and the sequence data to a device including a first display for displaying the first bingo ticket and the set of symbols being marked on the first bingo ticket according to the sequence data.

### Example 46

The machine (22) of example 45, wherein providing the multiple generated bingo tickets includes transmitting, by the processor over a communication network, at least a second bingo ticket of and the sequence data to a second device including a display for displaying the second bingo ticket and the set of symbols being marked on the second bingo ticket according to the sequence data.

### Example 47

The machine (22) any of any of examples 44 to 46, wherein selecting the set of symbols includes selecting multiple distinct symbols, and wherein the set of selectable symbols includes a scatter symbol, wherein the set of functions further comprises: determining, by the processor, a selected symbol of the set of symbols for the networked bingo match is the scatter symbol; determining, by the processor for each bingo ticket provided for the networked bingo match, a respective quantity of symbols to be marked on each bingo ticket provided for the networked bingo match in response to the scatter symbol being selected; selecting, by the processor for each bingo ticket provided for the networked bingo match, a quantity of unmarked symbols on the bingo ticket that equals the respective quantity of symbols selected for the bingo ticket; and marking, by the processor for each bingo ticket provided for the networked bingo match, each grid position on the bingo ticket that includes an unmarked symbol of the quantity of unmarked symbols selected for the bingo ticket.

### Example 48

The machine (22) of example 47, wherein determining each respective quantity of symbols includes selecting, by the processor, a number using a random process.

### Example 49

The machine (22) of example 47, wherein selecting each additional unmarked symbol of the quantity of unmarked symbols for the bingo tickets provided for the networked bingo match is conditioned on determining, by the processor, that marking an unmarked symbol on one or more of the bingo tickets provided for the networked bingo match does not result in the winning bingo ticket winning the networked bingo match.

### Example 50

The machine (22) of any of examples 47 to 49, wherein the scatter symbol is selectable for determining the bingo ticket that wins the networked bingo match but is not selectable for generating any of the computer-readable bingo tickets.

### Example 51

The machine (22) of any of examples 47 to 49, wherein the scatter symbol is selectable for determining the bingo ticket that wins the networked bingo match and is selectable for generating any of the computer-readable bingo tickets.

### Example 52

The machine (22) of any of examples 44 to 51, wherein the set of functions further comprises: selecting, by the processor, the first bingo ticket to include a bonus-counter symbol; and selecting, by the processor, a first symbol on the first bingo ticket within a first grid position for including the bonus-counter symbol on the first bingo ticket, wherein generating the first bingo ticket includes generating the first bingo ticket to include the first symbol and the bonus-counter symbol within the first grid position.

### Example 53

The machine (22) of example 52, wherein selecting the set of symbols for the networked bingo match includes selecting the first symbol from among the set of selectable symbols, wherein the set of functions further comprises: storing, by a computer-readable medium, for each bingo ticket provided for the networked bingo match that includes the first symbol, data representing a grid position including the first symbol for the bingo ticket is a marked grid position for a remainder of the networked bingo match; storing, by the computer-readable medium, a respective bonus-counter symbol counter for each player provided with at least one bingo ticket for the networked bingo match; and after selecting the first symbol, adjusting, by the processor, the respective bonus-counter symbol counter for each bingo ticket provided for the networked bingo match that includes the first symbol and the bonus-counter symbol in a single grid position within the bingo ticket.

### Example 54

The machine (22) of example 53, wherein adjusting the respective bonus-counter symbol counter for each bingo ticket includes incrementing or decrementing the respective bonus-counter symbol counter.

### Example 55

The machine (22) of any of examples 53 to 54, wherein the set of functions further comprises: selecting, by the processor, the first bingo ticket including the bonus-counter symbol to include a multiplier symbol; and selecting, by the processor, a second symbol on the first bingo ticket within a second grid position for including the multiplier symbol on the first bingo ticket, wherein generating the first bingo ticket includes generating the first bingo ticket to include the second symbol and the multiplier symbol within the second grid position.

### Example 56

The machine (22) of example 55, wherein selecting the set of symbols for the networked bingo match includes selecting the second symbol from among the set of selectable symbols, wherein the set of functions further comprises: storing, by a computer-readable medium, for each bingo ticket provided for the networked bingo match that includes the second symbol, data representing a grid position including the second symbol for the bingo ticket is a marked grid position for a remainder of the networked bingo match; storing, by the computer-readable medium, a respective post-multiplier-symbol-selection counter for each bingo ticket for the networked bingo game including the second symbol and a multiplier symbol in a single grid position; and after selecting the second symbol that is within second grid position including the multiplier symbol, setting by the processor, the post-multiplier-symbol-selection counter for the first bingo ticket, to an initial value, wherein adjusting the bonus-counter symbol counter for the first bingo ticket includes adjusting the bonus-counter symbol counter by a value of one times a multiplier value associated with the multiplier symbol if the post-multiplier-symbol-selection counter has not been adjusted to a final value, otherwise, adjusting the bonus-counter symbol counter for the bingo ticket includes adjusting the bonus-counter symbol counter by the value of one.

### Example 57

The machine (22) of example 56, wherein adjusting bonus-counter symbol counter by the value of one times the multiplier value associated with the multiplier symbol is conditioned on selecting the first symbol after selecting the second symbol.

### Example 58

The machine (22) of any one of examples 56 to 57, wherein the set of functions further comprises: after selecting the second symbol that is within second grid position including the multiplier symbol, and prior to selecting the first symbol that is within the grid position including the bonus-counter symbol, and after selecting at least one other symbol from among the set of selectable symbols for the networked bingo match, adjusting, by the processor, the post-multiplier-symbol-selection counter by a value of one for each of the at least one other symbol selected until the post-multiplier-symbol-section counter equals the final value.

### Example 59

The machine (22) of example 56, wherein adjusting bonus-counter symbol counter by the value of one times the multiplier value associated with the multiplier symbol is conditioned on selecting the first symbol before selecting the second symbol.

### Example 60

The machine (22) of example any of examples 53 to 59, wherein the set of functions further comprises: determining, by the processor, the bonus-counter symbol counter for the first bingo ticket is adjusted to a predefined threshold value; transmitting, by the processor to a device displaying the first bingo ticket, an indicator that indicates a bingo player using the device displaying the first bingo ticket is qualified to play a jackpot game; receiving, by the processor, a request to activate the jackpot game; and setting, by the processor, the bonus-counter symbol counter to an initial bonus-counter symbol counter value.

### Example 61

The machine (22) of example any of examples 55 to 60, wherein the multiplier symbol is associated with a multiplier value, and wherein the multiplier value is a positive integer within a range of 2 to 5, inclusive.

### Example 62

The machine (22) of example 61, wherein the multiplier value is 2.

### Example 63

The machine (22) of any of examples 44 to 62, wherein the processor randomly selects bingo tickets to include a bonus-counter symbol, and wherein at least one of the multiple generated bingo tickets for use in the networked bingo match does not include a bonus-counter symbol and at least one of the multiple generated bingo tickets for use in the networked bingo match includes a bonus-counter symbol.

### Example 64

The machine (22) of any of examples 44 to 63, wherein the bonus-counter symbol comprises a medallion symbol.

### Example 65

The machine (22) of any of examples 45 to 64, wherein the set of functions further comprises: selecting, by the processor, the first bingo ticket to include a bonus trigger symbol, and selecting, by the processor, a third symbol on the first bingo ticket within a third grid position for including the bonus trigger symbol, wherein generating the first bingo ticket includes generating the first bingo ticket to include the third symbol and the bonus trigger symbol within the third grid position.

### Example 66

The machine (22) of example 65, wherein selecting the set of symbols from among the set of selectable symbols for the networked bingo match includes selecting the third symbol, wherein the set of functions further comprises: storing, by a computer-readable medium, for each bingo ticket provided for the networked bingo match that includes the third symbol, data representing a grid position including the third symbol for the bingo ticket is a marked grid position for a remainder of the networked bingo match; storing, by the data storage device, a bonus-trigger-symbol counter for the first bingo ticket; setting, by the processor, the. bonus-trigger-symbol counter for the first bingo ticket to an initial value; and in response to selecting the third symbol during the networked bingo match, selecting at least one additional symbol, other than the third symbol, on the first bingo ticket and marking each grid position on the first bingo ticket including a symbol of the at least one additional symbol.

### Example 67

The machine (22) of example 66, wherein marking each grid position on the first bingo ticket including a symbol of the at least one additional symbol includes marking at least one grid position in a column on the first bingo ticket such that all grid positions in the column are marked.

### Example 68

The machine (22) of example 67, wherein the column includes the third symbol.

### Example 69

The machine (22) of example 66, wherein marking each grid position on the first bingo ticket including a symbol of the at least one additional symbol includes marking at least one grid position in a row on the first bingo ticket such that all grid positions in the row are marked.

### Example 70

The machine (22) of example 69, wherein the row includes the third symbol.

### Example 71

The machine (22) of example 66, wherein marking each grid position on the first bingo ticket including a symbol of the at least one additional symbol includes marking a quantity of unmarked grid positions on the first bingo ticket, and wherein the processor selects the unmarked grid positions from among any remaining unmarked grid positions on the first bingo ticket randomly.

### Example 72

The machine (22) of any of examples 66 to 71, wherein the set of functions further comprises: adjusting, by the processor, the bonus-trigger-symbol counter for the first bingo ticket in response to selecting, by the processor, a symbol from the set of selectable symbols while the bonus-trigger-symbol counter for the first bingo ticket is set to the initial value or to a value between the initial value and an end value of the bonus-trigger-symbol counter for the first bingo ticket; storing, by the data storage device, data representing each grid position on the first bingo ticket including a symbol of the at least one additional symbol is a marked grid position for the networked bingo match; and modifying, by the processor in response to the processor adjusting the bonus-trigger-symbol counter for the first bingo ticket to the end value during the first networked bingo match, the data representing each grid position on the first bingo ticket including a symbol of the at least one additional symbol is a marked grid position for the networked bingo match to indicate the symbol of the at least one additional symbol is an unmarked grid position for the networked bingo match if the symbol of the at least one addition symbol was not selected during a time when the bonus-trigger-symbol counter for the first bingo ticket was the initial value or a value between the initial value and the end value during the first networked bingo match.

### Example 73

The machine (22) of any of examples 66 to 71, wherein adjusting the bonus-trigger-symbol counter for the first bingo ticket includes incrementing or decrementing the bonus-trigger-symbol counter for the first bingo ticket.

### Example 74

The machine (22) of an of examples 65 to 73, wherein each of the other bingo tickets of the multiple generated bingo tickets includes the bonus trigger symbol and a symbol selectable from the set of selectable symbols within a single grid position of the other bingo ticket, wherein the set of functions further comprises: storing, by the data storage device, a respective bonus-trigger-symbol counter for the each of the other bingo tickets of the multiple generated bingo tickets; and in response to selecting the symbol selectable from the set of selectable symbols within the single grid position of the other bingo ticket during the networked bingo match, selecting at least one additional symbol, on the other bingo ticket and marking each grid position on the other bingo ticket including a symbol of the at least one additional symbol.

### Example 75

The machine (22) of example 74, wherein the set of functions further comprises: adjusting, by the processor, the bonus-trigger-symbol counter for the other bingo ticket in response to selecting, by the processor, a symbol from the set of selectable symbols while the bonus-trigger-symbol counter for the other bingo ticket is set to the initial value or to a value between the initial value and an end value of the bonus-trigger-symbol counter for the other bingo ticket; storing, by the data storage device, data representing each grid position on the other bingo ticket including a symbol of the at least one additional symbol on the other bingo ticket is a marked grid position for the networked bingo match; and modifying, by the processor in response to the processor adjusting the bonus-trigger-symbol counter for the other bingo ticket to the end value during the first networked bingo match, the data representing each grid position on the other bingo ticket including a symbol of the at least one additional symbol is a marked grid position for the networked bingo match to indicate the symbol of the at least one additional symbol is an unmarked grid position for the networked bingo match if the symbol of the at least one addition symbol was not selected during a time when the bonus-trigger-symbol counter for the other bingo ticket was the initial value or a value between the initial value and the end value during the first networked bingo match.

### Example 76

The machine (22) of any of examples 45 to 75, wherein each generated bingo ticket includes a set of grid positions; wherein the set of functions further comprises: selecting, by the processor for each grid position of multiple grid positions on each generated bingo ticket and from among the set of selectable symbols, a symbol to be positioned within the grid position; and storing, by a computer-readable medium, data representing each generated bingo ticket, wherein the data representing each generated bingo ticket includes data indicating a symbol selected to be positioned within a grid position of the multiple grid positions on the bingo ticket.

### Example 77

The machine (22) of example 76, wherein the set of functions further comprises: selecting, by the processor, at least one grid position on each generated bingo ticket to be a free space, wherein the data representing each generated bingo ticket includes data indicating the free space to be positioned within a grid position on the bingo ticket.

### Example 78

The machine (22) of any of examples 45 to 77, wherein the set of selectable symbols includes each integer within the range of 1 to 75, inclusive.

### Example 79

The machine (22) of example 78, wherein the set of selectable symbols further includes a scatter symbol.

### Example 80

The machine (22) of any of examples 78 to 79, wherein generating each bingo ticket of the multiple generated bingo tickets includes generating a bingo ticket with three grids, each grid including a five by five matrix of grid positions.

### Example 81

The machine (22) of any of examples 43 to 80, wherein the set of selectable symbols includes each integer within the range of 1 to 90, inclusive.

### Example 82

The machine example 81, wherein the set of selectable symbols further includes a scatter symbol.

### Example 83

The machine (22) of any of examples 81 to 82, wherein generating each bingo ticket of the multiple generated bingo tickets includes generating a bingo ticket with six grids, each grid including a three by nine matrix of grid positions.

### Example 84

The machine (22) of any of examples 45 to 83, wherein selecting each symbol of the set of symbols for the networked bingo match includes generating, by the processor, a random number associated with the symbol.

### Example 85

The machine (22) of any of examples 45 to 84, wherein the set of functions further comprises: receiving, by the processor, an indication of a payment for generating the first bingo ticket; validating, by the processor, the payment; updating, by the processor, a profile of a client device; transmitting, by the processor, an indication of success to the client device; and transmitting, by the processor, an indication of a user-name and a password to the client device.

### Example 86

The machine (22) of any of examples 45 to 85, wherein marking any grid position on a bingo ticket including a symbol from the set of selectable symbols within the any grid position includes marking the symbol within the any grid position.

### Example 87

The machine (22) of any of examples 45 to 86, wherein the machine includes a server machine configured to provide at least one generated bingo ticket of the multiple generated bingo tickets over a communication network to a client machine of a set of multiple client machines.

### Example 88

The (22) machine of example 87, further comprising: a communication interface to transmit the generated bingo ticket and data for presenting the networked bingo match at the multiple client device.

### Example 89

A method comprising: receiving, by a communication interface from a communication network, a first bingo ticket generated for use in a networked bingo match; receiving, by the communication interface from the communication network, a set of symbols selected for multiple bingo tickets competing in the networked bingo match from among a set of symbols selectable for the networked bingo match; displaying, by a display (25), the received first bingo ticket; and displaying, by the display (25), the received set of selected symbols being marked on the displayed first bingo ticket to display an outcome of the networked bingo match.

### Example 90

The method of example 89, the method further comprising: storing, by a computer-readable medium, the received first bingo ticket and the received set of selected symbols, wherein the received set of selected symbols includes or implies sequence data indicating a sequence of multiple distinct symbols from a first selected symbol to a last selected symbol, and wherein displaying the received set of selected symbols being marked on the displayed first bingo ticket includes displaying the received set of selected symbols being marked according to the sequence of multiple distinct symbols from the first selected symbol to the last selected symbol.

### Example 91

The method of example 90, wherein, for the networked bingo match, the received first bingo ticket competes against at least a second bingo ticket having the set of symbols selected for the networked bingo match being marked on the second bingo ticket according to the sequence data.

### Example 92

The method any of any of examples 89 to 91, wherein the set of selected symbols includes a scatter symbol that applies to the multiple bingo tickets generated for use in the networked bingo match, and wherein the scatter symbol is not selectable for generating the multiple bingo tickets competing in the networked bingo match, the method further comprising: receiving, by the communication interface from the communication network, a selected quantity of unmarked symbols on the first bingo ticket that equals a quantity of symbols selected for the first bingo ticket in response to the scatter symbol being selected as part of the set of selected symbols; displaying, by the display (25), an indication the scatter symbol was selected for the networked bingo game; and displaying, by the display (25), marking each grid position on the first bingo ticket that includes an unmarked symbol of the quantity of unmarked symbols selected for the first bingo ticket.

### Example 93

The method of example 92, wherein the quantity of symbols is a number selected using a random process.

### Example 94

The method of example 92, wherein displaying the marking each grid position on the first bingo ticket that includes an unmarked symbol of the quantity of unmarked symbols for the first bingo ticket is conditioned on one or more of the multiple bingo tickets competing in the networked bingo match not winning the networked bingo match.

### Example 95

The method of any of examples 89 to 94, wherein the first bingo ticket includes multiple symbols, including a first symbol, from a set of symbols defined for generating bingo tickets, wherein the first bingo ticket includes a bonus-counter symbol, and wherein displaying the first bingo ticket includes displaying the first symbol and the bonus-counter symbol within a first grid position selected for including the first symbol and the bonus-counter symbol on the first bingo ticket.

### Example 96

The method of example 95, wherein each symbol of the set of symbols defined for generating bingo tickets is a numerical symbol, and wherein the bonus-counter symbol is a non-numerical symbol.

### Example 97

The method of example 95, wherein each symbol of the set of symbols defined for generating bingo tickets includes a numerical symbol within a range of consecutive integers, and wherein the bonus-counter symbol includes an integer outside of the range of consecutive integers.

### Example 98

The method of any of examples 95 to 97, wherein the outcome of the networked bingo match is conditioned on applying the set of symbols selected for the networked bingo match to one or more other bingo tickets generated for the networked bingo match, and wherein at least one bingo ticket of the one or more other bingo tickets does not include the bonus-counter symbol.

### Example 99

The method of example 98, wherein at least one bingo ticket of the one or more other bingo tickets includes the bonus-counter symbol.

### Example 100

The method of example 95, wherein the set of symbols defined for generating the bingo ticket does not include the bonus-counter symbol, and wherein the set of symbols selectable for the networked bingo match does not include the bonus-counter symbol.

### Example 101

The method of example 95, wherein the set of selected symbols for the networked bingo match includes the first symbol from among the set of selectable symbols, the method further comprising: displaying, by the display (25), the first grid position including the first symbol and the bonus-counter symbol as a marked grid position for a remainder of the networked bingo match; displaying, by the display (25), a bonus-counter symbol counter for the first bingo ticket provided for the networked bingo match; and after displaying the first grid position as a marked grid position, displaying, by the display (25), adjusting the bonus-counter symbol counter for the first bingo ticket.

### Example 102

The method of example 101, wherein adjusting the bonus-counter symbol counter for the first bingo ticket includes incrementing or decrementing the bonus-counter symbol counter.

### Example 103

The method of any of examples 101 to 102, wherein receiving the first bingo ticket includes receiving the first bingo ticket including, within a second grid position on the first bingo ticket, a multiplier symbol and a second symbol selected from the set of symbols defined for generating bingo tickets, and wherein displaying the first bingo ticket includes displaying, by the display (25), the first bingo ticket including, within the second grid position on the first bingo ticket, the multiplier symbol and the second symbol.

### Example 104

The method of example 103, the method further comprising: displaying, by the display (25), a post-multiplier-symbol-selection counter for the bingo ticket for the networked bingo game including the second symbol and the multiplier symbol in the second grid position; and after selection of the second symbol that is within second grid position including the multiplier symbol, displaying by the display (25), the post-multiplier-symbol-selection counter for the first bingo ticket, to an initial value, wherein adjusting the bonus-counter symbol counter for the first bingo ticket includes adjusting the bonus-counter symbol counter by a value of one times a multiplier value associated with the multiplier symbol if the post-multiplier-symbol-selection counter has not been adjusted to a final value, otherwise, adjusting the bonus-counter symbol counter for the bingo ticket includes adjusting the bonus-counter symbol counter by the value of one.

### Example 105

The method of example 104, wherein adjusting bonus-counter symbol counter by the value of one times the multiplier value associated with the multiplier symbol is conditioned on the first symbol being selected for marking after the second symbol is selected for marking.

### Example 106

The method of any one of examples 104 to 105, further comprising: after displaying the second symbol that is within second grid position including the multiplier symbol being marked, and prior to displaying the first symbol that is within the grid position including the bonus-counter symbol being marked, and after displaying at least one other symbol from among the set of selectable symbols for the networked bingo match being marked, adjusting, by the processor, the post-multiplier-symbol-selection counter by a value of one for each of the at least one other symbol displayed as being marked until the post-multiplier-symbol-section counter equals the final value.

### Example 107

The method of example 104, wherein adjusting bonus-counter symbol counter by the value of one times the multiplier value associated with the multiplier symbol is conditioned on the first symbol being selected for marking before the second symbol is selected for marking.

### Example 108

The method of example any of examples 101 to 107, further comprising: displaying, by the display (25), the bonus-counter symbol counter for the first bingo ticket is adjusted to a predefined threshold value; receiving, by the communication interface from the communication network, an indicator that indicates a bingo player using a device displaying the first bingo ticket is qualified to play a jackpot game; providing, by the communication interface to the communication network, a request to activate the jackpot game; and displaying, by the display the bonus-counter symbol counter being set back to an initial bonus-counter symbol counter value.

### Example 109

The method of example any of examples 103 to 108, wherein the multiplier symbol is associated with a multiplier value, and wherein the multiplier value is a positive integer within a range of 2 to 5, inclusive.

### Example 110

The method of example 109, wherein the multiplier value is 2.

### Example 111

The method of any of examples 89 to 110, wherein at least one of the multiple bingo tickets competing in the networked bingo match does not include a bonus-counter symbol and at least one of the multiple bingo tickets competing in the networked bingo match includes a bonus-counter symbol.

### Example 112

The method of any of examples 89 to 111, wherein the bonus-counter symbol comprises a medallion symbol.

### Example 113

The method of any of examples 90 to 112, further comprising: wherein the first bingo ticket includes a bonus trigger symbol and a third symbol, wherein the bonus trigger symbol and the third symbol are positioned within a third grid position on the first bingo ticket, and wherein displaying the first bingo ticket includes displaying the first bingo ticket including the third symbol and the bonus trigger symbol within the third grid position.

### Example 114

The method of example 113, wherein the set of selected symbols for the networked bingo match includes the third symbol from among the set of selectable symbols, the method further comprising: displaying, by the display (25), the third grid position including the third symbol and the bonus trigger symbol as a marked grid position for a remainder of the networked bingo match; displaying, by the display (25), a bonus-trigger-symbol counter set to an initial value for the first bingo ticket provided for the networked bingo match; displaying, by the display (25), at least one additional symbol, other than the third symbol, on the first bingo ticket and in response to selection of the third symbol for the networked bingo match, displaying each grid position on the first bingo ticket including a symbol of the at least one additional symbol as being marked.

### Example 115

The method of example 114, wherein marking each grid position on the first bingo ticket including a symbol of the at least one additional symbol includes marking at least one grid position in a column on the first bingo ticket such that all grid positions in the column are marked.

### Example 116

The method of example 115, wherein the column includes the third symbol.

### Example 117

The method of example 114, wherein marking each grid position on the first bingo ticket including a symbol of the at least one additional symbol includes marking at least one grid position in a row on the first bingo ticket such that all grid positions in the row are marked.

### Example 118

The method of example 117, wherein the row includes the third symbol.

### Example 119

The method of example 114, wherein marking each grid position on the first bingo ticket including a symbol of the at least one additional symbol includes marking a quantity of unmarked grid positions on the first bingo ticket, and wherein the unmarked grid positions are selected from among any remaining unmarked grid positions on the first bingo ticket randomly.

### Example 120

The method of any of examples 114 to 119, further comprising: displaying, by the display (25), the bonus-trigger-symbol counter for the first bingo ticket being adjusted in response to selection of a symbol from the set of selectable symbols while the bonus-trigger-symbol counter for the first bingo ticket is set to the initial value or to a value between the initial value and an end value of the bonus-trigger-symbol counter for the first bingo ticket; displaying, by the display (25), each grid position on the first bingo ticket including a symbol of the at least one additional symbol as a marked grid position for the networked bingo match; and modifying, by the display in response to the bonus-trigger-symbol counter for the first bingo ticket being adjusted to the end value during the first networked bingo match, the displaying of each grid position on the first bingo ticket including a symbol of the at least one additional symbol being a marked grid position for the networked bingo match to indicate the symbol of the at least one additional symbol is an unmarked grid position for the networked bingo match if the symbol of the at least one addition symbol was not selected during a time when the bonus-trigger-symbol counter for the first bingo ticket was the initial value or a value between the initial value and the end value during the first networked bingo match.

### Example 121

The method of any of examples 114 to 119, wherein adjusting the bonus-trigger-symbol counter for the first bingo ticket includes incrementing or decrementing the bonus-trigger-symbol counter for the first bingo ticket.

### Example 122

The method of an of examples 113 to 121, wherein each of the other bingo tickets of the multiple bingo tickets competing in the networked bingo match includes the bonus trigger symbol and a symbol selectable from the set of selectable symbols within a single grid position of the other bingo ticket, wherein a respective bonus-trigger-symbol counter for the each of the other bingo tickets of the multiple generated bingo tickets is adjusted by a server; and wherein, in response to selecting the symbol selectable from the set of selectable symbols within the single grid position of the other bingo ticket during the networked bingo match, selecting at least one additional symbol, on the other bingo ticket and marking each grid position on the other bingo ticket including a symbol of the at least one additional symbol.

### Example 123

The method of any of examples 90 to 122, wherein the first bingo ticket includes a set of multiple grid positions; wherein receiving the first bingo ticket includes receiving the first bingo ticket including multiple grid positions on the first bingo ticket and from among the set of selectable symbols a symbol to be positioned within each grid position of the multiple grid positions, and wherein displaying the first bingo ticket includes displaying, by the display (25), the first bingo ticket including the multiple grid positions on the first bingo ticket and from among the set of selectable symbols the symbol positioned within each grid position of the multiple grid positions.

### Example 124

The method of example 123, further comprising: wherein receiving the first bingo ticket includes receiving the first bingo ticket including at least one grid position on the first bingo ticket to be a free space, and wherein displaying the first bingo ticket includes displaying, by the display (25), the free space positioned within the at least one grid position on the first bingo ticket.

### Example 125

The method of any of examples 90 to 124, wherein the set of symbols selectable for the networked bingo match includes each integer within the range of 1 to 75, inclusive.

### Example 126

The method of example 125, wherein the set of symbols selectable for the networked bingo match further includes a scatter symbol.

### Example 127

The method of any of examples 125 to 126, wherein each bingo ticket of the multiple generated bingo tickets competing in the networked bingo match includes three grids, each grid including a five by five matrix of grid positions.

### Example 128

The method of any of examples 90 to 127, wherein the set symbols selectable for the networked bingo match includes each integer within the range of 1 to 90, inclusive.

### Example 129

The method example 128, wherein the set of symbols selectable for the networked bingo match further includes a scatter symbol.

### Example 130

The method of any of examples 128 to 129, wherein each bingo ticket of the multiple generated bingo tickets competing in the networked bingo match includes six grids, each grid including a three by nine matrix of grid positions.

### Example 131

The method of any of examples 90 to 130, wherein each symbol of the set of symbols selected for the multiple bingo tickets competing in the networked bingo match is selected based on generating a random number associated with the symbol.

### Example 132

The method of any of examples 90 to 131, further comprising: providing, by the communication interface to the communication network, an indication of a payment for generating the first bingo ticket; receiving, by the communication interface from the communication network, an indication of successful payment; and receiving, by the communication interface from the communication network, an indication of a user-name and a password.

### Example 133

The method of any of examples 90 to 132, wherein marking a particular grid position on the first bingo ticket including a symbol from the set of selectable symbols within the particular grid position includes marking the symbol within the particular grid position.

### Example 134

A machine (24) comprising: a computer-readable processor; a display; a communication interface; and a computer-readable data storage medium storing computer-readable program instructions, that when executed by the processor, cause a set of functions to be performed, the set of functions comprising: receiving, by a communication interface from a communication network, a first bingo ticket generated for use in a networked bingo match; receiving, by the communication interface from the communication network, a set of symbols selected for multiple bingo tickets competing in the networked bingo match from among a set of symbols selectable for the networked bingo match; displaying, by a display (25), the received first bingo ticket; and displaying, by the display (25), the received set of selected symbols being marked on the displayed first bingo ticket to display an outcome of the networked bingo match.

### Example 135

The machine (24) of example 134, the set of functions further comprising: storing, by a computer-readable medium, the received first bingo ticket and the received set of selected symbols, wherein the received set of selected symbols includes or implies sequence data indicating a sequence of multiple distinct symbols from a first selected symbol to a last selected symbol, and wherein displaying the received set of selected symbols being marked on the displayed first bingo ticket includes displaying the received set of selected symbols being marked according to the sequence of multiple distinct symbols from the first selected symbol to the last selected symbol.

### Example 136

The machine (24) of example 135, wherein, for the networked bingo match, the received first bingo ticket competes against at least a second bingo ticket having the set of symbols selected for the networked bingo match being marked on the second bingo ticket according to the sequence data.

### Example 137

The machine (24) any of any of examples 134 to 136, wherein the set of selected symbols includes a scatter symbol that applies to the multiple bingo tickets generated for use in the networked bingo match, and wherein the scatter symbol is not selectable for generating the multiple bingo tickets competing in the networked bingo match, the set of functions further comprising: receiving, by the communication interface from the communication network, a selected quantity of unmarked symbols on the first bingo ticket that equals a quantity of symbols selected for the first bingo ticket in response to the scatter symbol being selected as part of the set of selected symbols; displaying, by the display (25), an indication the scatter symbol was selected for the networked bingo game; and displaying, by the display (25), marking each grid position on the first bingo ticket that includes an unmarked symbol of the quantity of unmarked symbols selected for the first bingo ticket.

### Example 138

The machine (24) of example 137, wherein the quantity of symbols is a number selected using a random process.

### Example 139

The machine (24) of example 137, wherein displaying the marking each grid position on the first bingo ticket that includes an unmarked symbol of the quantity of unmarked symbols for the first bingo ticket is conditioned on one or more of the multiple bingo tickets competing in the networked bingo match not winning the networked bingo match.

### Example 140

The machine (24) of any of examples 134 to 139, wherein the first bingo ticket includes multiple symbols, including a first symbol, from a set of symbols defined for generating bingo tickets, wherein the first bingo ticket includes a bonus-counter symbol, and wherein displaying the first bingo ticket includes displaying the first symbol and the bonus-counter symbol within a first grid position selected for including the first symbol and the bonus-counter symbol on the first bingo ticket.

### Example 141

The machine (24) of example 140, wherein each symbol of the set of symbols defined for generating bingo tickets is a numerical symbol, and wherein the bonus-counter symbol is a non-numerical symbol.

### Example 142

The machine (24) of example 140, wherein each symbol of the set of symbols defined for generating bingo tickets includes a numerical symbol within a range of consecutive integers, and wherein the bonus-counter symbol includes an integer outside of the range of consecutive integers.

### Example 143

The machine (24) of any of examples 140 to 142, wherein the outcome of the networked bingo match is conditioned on applying the set of symbols selected for the networked bingo match to one or more other bingo tickets generated for the networked bingo match, and wherein at least one bingo ticket of the one or more other bingo tickets does not include the bonus-counter symbol.

### Example 144

The machine (24) of example 143, wherein at least one bingo ticket of the one or more other bingo tickets includes the bonus-counter symbol.

### Example 145

The machine (24) of example 140, wherein the set of symbols defined for generating the bingo ticket does not include the bonus-counter symbol, and wherein the set of symbols selectable for the networked bingo match does not include the bonus-counter symbol.

### Example 146

The machine (24) of example 140, wherein the set of selected symbols for the networked bingo match includes the first symbol from among the set of selectable symbols, the set of functions further comprising: displaying, by the display (25), the first grid position including the first symbol and the bonus-counter symbol as a marked grid position for a remainder of the networked bingo match; displaying, by the display (25), a bonus-counter symbol counter for the first bingo ticket provided for the networked bingo match; and after displaying the first grid position as a marked grid position, displaying, by the display (25), adjusting the bonus-counter symbol counter for the first bingo ticket.

### Example 147

The machine (24) of example 146, wherein adjusting the bonus-counter symbol counter for the first bingo ticket includes incrementing or decrementing the bonus-counter symbol counter.

### Example 148

The machine (24) of any of examples 146 to 147, wherein receiving the first bingo ticket includes receiving the first bingo ticket including, within a second grid position on the first bingo ticket, a multiplier symbol and a second symbol selected from the set of symbols defined for generating bingo tickets, and wherein displaying the first bingo ticket includes displaying, by the display (25), the first bingo ticket including, within the second grid position on the first bingo ticket, the multiplier symbol and the second symbol.

### Example 149

The machine (24) of example 148, the set of functions further comprising: displaying, by the display (25), a post-multiplier-symbol-selection counter for the bingo ticket for the networked bingo game including the second symbol and the multiplier symbol in the second grid position; and after selection of the second symbol that is within second grid position including the multiplier symbol, displaying by the display (25), the post-multiplier-symbol-selection counter for the first bingo ticket, to an initial value, wherein adjusting the bonus-counter symbol counter for the first bingo ticket includes adjusting the bonus-counter symbol counter by a value of one times a multiplier value associated with the multiplier symbol if the post-multiplier-symbol-selection counter has not been adjusted to a final value, otherwise, adjusting the bonus-counter symbol counter for the bingo ticket includes adjusting the bonus-counter symbol counter by the value of one.

### Example 150

The machine (24) of example 149, wherein adjusting bonus-counter symbol counter by the value of one times the multiplier value associated with the multiplier symbol is conditioned on the first symbol being selected for marking after the second symbol is selected for marking.

### Example 151

The machine (24) of any one of examples 149 to 150, further comprising: after displaying the second symbol that is within second grid position including the multiplier symbol being marked, and prior to displaying the first symbol that is within the grid position including the bonus-counter symbol being marked, and after displaying at least one other symbol from among the set of selectable symbols for the networked bingo match being marked, adjusting, by the processor, the post-multiplier-symbol-selection counter by a value of one for each of the at least one other symbol displayed as being marked until the post-multiplier-symbol-section counter equals the final value.

### Example 152

The machine (24) of example 149, wherein adjusting bonus-counter symbol counter by the value of one times the multiplier value associated with the multiplier symbol is conditioned on the first symbol being selected for marking before the second symbol is selected for marking.

### Example 153

The machine (24) of example any of examples 146 to 152, further comprising: displaying, by the display (25), the bonus-counter symbol counter for the first bingo ticket is adjusted to a predefined threshold value; receiving, by the communication interface from the communication network, an indicator that indicates a bingo player using a device displaying the first bingo ticket is qualified to play a jackpot game; providing, by the communication interface to the communication network, a request to activate the jackpot game; and displaying, by the display the bonus-counter symbol counter being set back to an initial bonus-counter symbol counter value.

### Example 154

The machine (24) of example any of examples 148 to 154, wherein the multiplier symbol is associated with a multiplier value, and wherein the multiplier value is a positive integer within a range of 2 to 5, inclusive.

### Example 155

The machine (24) of example 154, wherein the multiplier value is 2.

### Example 156

The machine (24) of any of examples 134 to 155, wherein at least one of the multiple bingo tickets competing in the networked bingo match does not include a bonus-counter symbol and at least one of the multiple bingo tickets competing in the networked bingo match includes a bonus-counter symbol.

### Example 157

The machine (24) of any of examples 134 to 156, wherein the bonus-counter symbol comprises a medallion symbol.

### Example 158

The machine (24) of any of examples 134 to 157, further comprising: wherein the first bingo ticket includes a bonus trigger symbol and a third symbol, wherein the bonus trigger symbol and the third symbol are positioned within a third grid position on the first bingo ticket, and wherein displaying the first bingo ticket includes displaying the first bingo ticket including the third symbol and the bonus trigger symbol within the third grid position.

### Example 159

The machine (24) of example 134, wherein the set of selected symbols for the networked bingo match includes the third symbol from among the set of selectable symbols, the set of functions further comprising: displaying, by the display (25), the third grid position including the third symbol and the bonus trigger symbol as a marked grid position for a remainder of the networked bingo match; displaying, by the display (25), a bonus-trigger-symbol counter set to an initial value for the first bingo ticket provided for the networked bingo match; displaying, by the display (25), at least one additional symbol, other than the third symbol, on the first bingo ticket and in response to selection of the third symbol for the networked bingo match, displaying each grid position on the first bingo ticket including a symbol of the at least one additional symbol as being marked.

### Example 160

The machine (24) of example 159, wherein marking each grid position on the first bingo ticket including a symbol of the at least one additional symbol includes marking at least one grid position in a column on the first bingo ticket such that all grid positions in the column are marked.

### Example 161

The machine (24) of example 160, wherein the column includes the third symbol.

### Example 162

The machine (24) of example 159, wherein marking each grid position on the first bingo ticket including a symbol of the at least one additional symbol includes marking at least one grid position in a row on the first bingo ticket such that all grid positions in the row are marked.

### Example 163

The machine (24) of example 162, wherein the row includes the third symbol.

### Example 164

The machine (24) of example 159, wherein marking each grid position on the first bingo ticket including a symbol of the at least one additional symbol includes marking a quantity of unmarked grid positions on the first bingo ticket, and wherein the unmarked grid positions are selected from among any remaining unmarked grid positions on the first bingo ticket randomly.

### Example 165

The machine (24) of any of examples 159 to 164, further comprising: displaying, by the display (25), the bonus-trigger-symbol counter for the first bingo ticket being adjusted in response to selection of a symbol from the set of selectable symbols while the bonus-trigger-symbol counter for the first bingo ticket is set to the initial value or to a value between the initial value and an end value of the bonus-trigger-symbol counter for the first bingo ticket; displaying, by the display (25), each grid position on the first bingo ticket including a symbol of the at least one additional symbol as a marked grid position for the networked bingo match; and modifying, by the display in response to the bonus-trigger-symbol counter for the first bingo ticket being adjusted to the end value during the first networked bingo match, the displaying of each grid position on the first bingo ticket including a symbol of the at least one additional symbol being a marked grid position for the networked bingo match to indicate the symbol of the at least one additional symbol is an unmarked grid position for the networked bingo match if the symbol of the at least one addition symbol was not selected during a time when the bonus-trigger-symbol counter for the first bingo ticket was the initial value or a value between the initial value and the end value during the first networked bingo match.

### Example 166

The machine (24) of any of examples 159 to 164, wherein adjusting the bonus-trigger-symbol counter for the first bingo ticket includes incrementing or decrementing the bonus-trigger-symbol counter for the first bingo ticket.

### Example 167

The machine (24) of an of examples 158 to 166, wherein each of the other bingo tickets of the multiple bingo tickets competing in the networked bingo match includes the bonus trigger symbol and a symbol selectable from the set of selectable symbols within a single grid position of the other bingo ticket, wherein a respective bonus-trigger-symbol counter for the each of the other bingo tickets of the multiple generated bingo tickets is adjusted by a server; and wherein, in response to selecting the symbol selectable from the set of selectable symbols within the single grid position of the other bingo ticket during the networked bingo match, selecting at least one additional symbol, on the other bingo ticket and marking each grid position on the other bingo ticket including a symbol of the at least one additional symbol.

### Example 168

The machine (24) of any of examples 134 to 167, wherein the first bingo ticket includes a set of multiple grid positions; wherein receiving the first bingo ticket includes receiving the first bingo ticket including multiple grid positions on the first bingo ticket and from among the set of selectable symbols a symbol to be positioned within each grid position of the multiple grid positions, and wherein displaying the first bingo ticket includes displaying, by the display (25), the first bingo ticket including the multiple grid positions on the first bingo ticket and from among the set of selectable symbols the symbol positioned within each grid position of the multiple grid positions.

### Example 169

The machine (24) of example 168, further comprising: wherein receiving the first bingo ticket includes receiving the first bingo ticket including at least one grid position on the first bingo ticket to be a free space, and wherein displaying the first bingo ticket includes displaying, by the display (25), the free space positioned within the at least one grid position on the first bingo ticket.

### Example 170

The machine (24) of any of examples 134 to 169, wherein the set of symbols selectable for the networked bingo match includes each integer within the range of 1 to 75, inclusive.

### Example 171

The machine (24) of example 170, wherein the set of symbols selectable for the networked bingo match further includes a scatter symbol.

### Example 172

The machine (24) of any of examples 170 to 171, wherein each bingo ticket of the multiple generated bingo tickets competing in the networked bingo match includes three grids, each grid including a five by five matrix of grid positions.

### Example 173

The machine (24) of any of examples 134 to 172, wherein the set symbols selectable for the networked bingo match includes each integer within the range of 1 to 90, inclusive.

### Example 174

The machine (24) example 173, wherein the set of symbols selectable for the networked bingo match further includes a scatter symbol.

### Example 175

The machine (24) of any of examples 173 to 174, wherein each bingo ticket of the multiple generated bingo tickets competing in the networked bingo match includes six grids, each grid including a three by nine matrix of grid positions.

### Example 176

The machine (24) of any of examples 134 to 175, wherein each symbol of the set of symbols selected for the multiple bingo tickets competing in the networked bingo match is selected based on generating a random number associated with the symbol.

### Example 177

The machine (24) of any of examples 134 to 176, further comprising: providing, by the communication interface to the communication network, an indication of a payment for generating the first bingo ticket; receiving, by the communication interface from the communication network, an indication of successful payment; and receiving, by the communication interface from the communication network, an indication of a user-name and a password.

### Example 178

The machine (24) of any of examples 134 to 177, wherein marking a particular grid position on the first bingo ticket including a symbol from the set of selectable symbols within the particular grid position includes marking the symbol within the particular grid position.

### XI. Conclusion

Example embodiments have been described above. Those skilled in the art will understand, however, that changes and modifications may be made to these embodiments without departing from the true scope and spirit of the invention, which is defined by the claims.

1. A method comprising:
generating, by a computer-readable processor, computer-readable bingo tickets;
providing, over a communication network, multiple generated bingo tickets for use in a networked bingo match, wherein the multiple generated bingo tickets include a first bingo ticket;
selecting, by the processor, the first bingo ticket to include a bonus-counter symbol;
selecting, by the processor, a first symbol on the first bingo ticket within a first grid position for including the bonus-counter symbol on the first bingo ticket;
selecting, by the processor and from among a set of selectable symbols, a set of symbols for the networked bingo match; and
determining, by the processor from among the multiple bingo tickets provided for use in the networked bingo match and based on the selected set of symbols, a winning bingo ticket that wins the networked bingo match.

2. (canceled)

3. The method of claim 1,
wherein selecting the set of symbols for the networked bingo match includes selecting the first symbol from among the set of selectable symbols,
the method further comprising:
storing, by a computer-readable medium, for each bingo ticket provided for the networked bingo match that includes the first symbol, data representing a grid position including the first symbol for the bingo ticket is a marked grid position for a remainder of the networked bingo match;
storing, by the computer-readable medium, a respective bonus-counter symbol counter for each player provided with at least one bingo ticket for the networked bingo match; and
after selecting the first symbol, adjusting, by the processor, the respective bonus-counter symbol counter for each player provided with at least one bingo ticket for the networked bingo match that includes the first symbol and the bonus-counter symbol in a single grid position within the bingo ticket.

4. (canceled)

5. The method of claim 3, further comprising:
selecting, by the processor, the first bingo ticket including the bonus-counter symbol to include a multiplier symbol; and
selecting, by the processor, a second symbol on the first bingo ticket within a second grid position for including the multiplier symbol on the first bingo ticket,
wherein generating the first bingo ticket includes generating the first bingo ticket to include the second symbol and the multiplier symbol within the second grid position.

6. The method of claim 5,
wherein selecting the set of symbols for the networked bingo match includes selecting the second symbol from among the set of selectable symbols,
the method further comprising:
storing, by a computer-readable medium, for each bingo ticket provided for the networked bingo match that includes the second symbol, data representing a grid position including the second symbol for the bingo ticket is a marked grid position for a remainder of the networked bingo match;
storing, by the computer-readable medium, a respective post-multiplier-symbol-selection counter for each bingo ticket for the networked bingo game including the second symbol and a multiplier symbol in a single grid position; and
after selecting the second symbol that is within second grid position including the multiplier symbol, setting by the processor, the post-multiplier-symbol-selection counter for the first bingo ticket, to an initial value,
wherein adjusting the bonus-counter symbol counter for the first bingo ticket includes adjusting the bonus-counter symbol counter by a value of one times a multiplier value associated with the multiplier symbol if the post-multiplier-symbol-selection counter has not been adjusted to a final value, otherwise, adjusting the bonus-counter symbol counter for the bingo ticket includes adjusting the bonus-counter symbol counter by the value of one.

7. The method of claim 6, further comprising:
after selecting the second symbol that is within second grid position including the multiplier symbol, and prior to selecting the first symbol that is within the grid position including the bonus-counter symbol, and after selecting at least one other symbol from among the set of selectable symbols for the networked bingo match, adjusting, by the processor, the post-multiplier-symbol-selection counter by a value of one for each of the at least one other symbol selected until the post-multiplier-symbol-section counter equals the final value.

8. The method of claim 3, further comprising:
determining, by the processor, the bonus-counter symbol counter for the first bingo ticket is adjusted to a predefined threshold value;
transmitting, to a device displaying the first bingo ticket, an indicator that indicates a bingo player using the device displaying the first bingo ticket is qualified to play a jackpot game;
receiving, by the processor, a request to activate the jackpot game; and
setting, by the processor, the bonus-counter symbol counter to an initial bonus-counter symbol counter value.

9. The method of claim 1,
wherein each generated bingo ticket includes a set of multiple grid positions;
the method further comprising:
selecting, by the processor for each grid position of multiple grid positions on each generated bingo ticket and from among the set of selectable symbols, a symbol to be positioned within the grid position; and
storing, by a computer-readable medium, data representing each generated bingo ticket, wherein the data representing each generated bingo ticket includes data indicating a symbol selected to be positioned within a grid position of the multiple grid positions on the bingo ticket.

10. (canceled)

11. A machine comprising:
a computer-readable processor; and
a computer-readable data storage medium storing computer-readable program instructions, that when executed by the processor, cause a set of functions to be performed, the set of functions comprising:
generating, by a computer-readable processor, computer-readable bingo tickets;
providing, over a communication network, multiple generated bingo tickets for use in a networked bingo match, wherein the multiple generated bingo tickets include a first bingo ticket;
selecting, by the processor, the first bingo ticket to include a bonus-counter symbol;
selecting, by the processor, a first symbol on the first bingo ticket within a first grid position for including the bonus-counter symbol on the first bingo ticket;
selecting, by the processor and from among a set of selectable symbols, a set of symbols for the networked bingo match; and
determining, by the processor from among the multiple bingo tickets provided for use in the networked bingo match and based on the selected set of symbols, a winning bingo ticket that wins the networked bingo match.

12-20. (canceled)

21. A method comprising:
receiving, by a communication interface from a communication network, a first bingo ticket generated for use in a networked bingo match, wherein the first bingo ticket includes multiple symbols, including a first symbol, from a set of symbols defined for generating bingo tickets, and wherein the first bingo ticket includes a bonus-counter symbol;
receiving, by the communication interface from the communication network, a set of symbols selected for multiple bingo tickets competing in the networked bingo match from among a set of symbols selectable for the networked bingo match;
displaying, by a display, the received first bingo ticket, wherein displaying the first bingo ticket includes displaying the first symbol and the bonus-counter symbol within a first grid position selected for including the first symbol and the bonus-counter symbol on the first bingo ticket; and
displaying, by the display, the received set of selected symbols being marked on the displayed first bingo ticket to display an outcome of the networked bingo match.

22. The method of claim 21,
wherein each symbol of the set of symbols defined for generating bingo tickets is a numerical symbol, and
wherein the bonus-counter symbol is a non-numerical symbol.

23. The method of claim 21,
wherein each symbol of the set of symbols defined for generating bingo tickets includes a numerical symbol within a range of consecutive integers, and
wherein the bonus-counter symbol includes an integer outside of the range of consecutive integers.

24. The method of claim 21,
wherein the outcome of the networked bingo match is conditioned on applying the set of symbols selected for the networked bingo match to one or more other bingo tickets generated for the networked bingo match, and
wherein at least one bingo ticket of the one or more other bingo tickets does not include the bonus-counter symbol.

25. The method of claim 24, wherein at least one bingo ticket of the one or more other bingo tickets includes the bonus-counter symbol.

26. The method of claim 21,
wherein the set of symbols defined for generating the bingo ticket does not include the bonus-counter symbol, and
wherein the set of symbols selectable for the networked bingo match does not include the bonus-counter symbol.

27. The method of claim 21,
wherein the set of selected symbols for the networked bingo match includes the first symbol from among the set of selectable symbols,
the method further comprising:
displaying, by the display, the first grid position including the first symbol and the bonus-counter symbol as a marked grid position for a remainder of the networked bingo match;
displaying, by the display, a bonus-counter symbol counter for the first bingo ticket provided for the networked bingo match; and
after displaying the first grid position as a marked grid position, displaying, by the display, adjusting the bonus-counter symbol counter for the first bingo ticket.

28. The method of claim 21,
wherein receiving the first bingo ticket includes receiving the first bingo ticket including, within a second grid position on the first bingo ticket, a multiplier symbol and a second symbol selected from the set of symbols defined for generating bingo tickets, and
wherein displaying the first bingo ticket includes displaying, by the display, the first bingo ticket including, within the second grid position on the first bingo ticket, the multiplier symbol and the second symbol.

29. The method of claim 28, the method further comprising:
displaying, by the display, a post-multiplier-symbol-selection counter for the bingo ticket for the networked bingo game including the second symbol and the multiplier symbol in the second grid position; and
after selection of the second symbol that is within second grid position including the multiplier symbol, displaying by the display, the post-multiplier-symbol-selection counter for the first bingo ticket, to an initial value,
wherein adjusting the bonus-counter symbol counter for the first bingo ticket includes adjusting the bonus-counter symbol counter by a value of one times a multiplier value associated with the multiplier symbol if the post-multiplier-symbol-selection counter has not been adjusted to a final value, otherwise, adjusting the bonus-counter symbol counter for the bingo ticket includes adjusting the bonus-counter symbol counter by the value of one.

30. The method of claim 29, further comprising:
after displaying the second symbol that is within second grid position including the multiplier symbol being marked, and prior to displaying the first symbol that is within the grid position including the bonus-counter symbol being marked, and after displaying at least one other symbol from among the set of selectable symbols for the networked bingo match being marked, adjusting, by the processor, the post-multiplier-symbol-selection counter by a value of one for each of the at least one other symbol displayed as being marked until the post-multiplier-symbol-section counter equals the final value.

31. The method of claim 27, further comprising:
displaying, by the display, the bonus-counter symbol counter for the first bingo ticket is adjusted to a predefined threshold value;
receiving, by the communication interface from the communication network, an indicator that indicates a bingo player using a device displaying the first bingo ticket is qualified to play a jackpot game;
providing, by the communication interface to the communication network, a request to activate the jackpot game; and
displaying, by the display the bonus-counter symbol counter being set back to an initial bonus-counter symbol counter value.

32. (canceled)

33. A machine comprising:
a computer-readable processor;
a display;
a communication interface; and
a computer-readable data storage medium storing computer-readable program instructions, that when executed by the processor, cause a set of functions to be performed, the set of functions comprising:
receiving, by the communication interface from a communication network, a first bingo ticket generated for use in a networked bingo match, wherein the first bingo ticket includes multiple symbols, including a first symbol, from a set of symbols defined for generating bingo tickets, and wherein the first bingo ticket includes a bonus-counter symbol;
receiving, by the communication interface from the communication network, a set of symbols selected for multiple bingo tickets competing in the networked bingo match from among a set of symbols selectable for the networked bingo match;
displaying, by the display, the received first bingo ticket, wherein displaying the first bingo ticket includes displaying the first symbol and the bonus-counter symbol within a first grid position selected for including the first symbol and the bonus-counter symbol on the first bingo ticket; and
displaying, by the display, the received set of selected symbols being marked on the displayed first bingo ticket to display an outcome of the networked bingo match.

34-114. (canceled)
